(19) United States
(12) Patent Application Publication
(10) Pub. No.: US 2016/0232017 A1
(43) Pub. Date: Aug. 11, 2016

(54) System and Method for Reloading Constructors

(71) Applicant: ZeroTurnaround AS, Tartu (EE)

(72) Inventor: Allan Raundahl Gregersen, Tartu (EE)

(21) Appl. No.: 15/019,529

(22) Filed: Feb. 9, 2016

Related U.S. Application Data
(60) Provisional application No. 62/114,223, filed on Feb. 10, 2015.

(51) Int. Cl. G06F 9/455; G06F 9/44; G06F 9/45; G06F 9/445

(52) U.S. Cl. CPC G06F 9/45508; G06F 8/65; G06F 8/30; G06F 8/447

(57) ABSTRACT

A system and method for reloading constructors of existing classes of a user application (user app) running on a user device is disclosed. A service module application running on a host system detects changes to the classes, stores and assigns an identifier for each constructor of each changed class and associated original class, creates a set of transformed classes for the original classes and helper classes for the changed classes using the identifiers, and sends the transformed classes and the helper classes to the user device for loading by the user app to accomplish the reloading of the constructors. The method preferably enables class reloading of constructors of class files of Java-based user apps executing within an Android Virtual Machine (VM) on the user devices, where the Android VM preferably runs on top of an Android-based operating system of the user devices.

### RELATED APPLICATIONS

This application claims the benefit under 35 U.S.C. §119(e) of U.S. Provisional Application No. 62/114,223, filed on Feb. 10, 2015, which is incorporated herein by reference in its entirety.

### BACKGROUND OF THE INVENTION

User devices is a term that applies to computer systems such as desktop computers, smart televisions (TVs) and mobile computing devices such as laptop computers, mobile phones, tablets, “smart” watches, and eye-glasses, to list a few examples. More specific examples of user devices include smartphones, tablet computing devices, and laptop computers running operating systems such as Windows, Android, Linux, or IOS, in examples.

Software developers are increasingly utilizing modern software development platforms to enable the creation of machine-independent applications for installation and execution on different target user devices, or simply user devices. Unlike machine-dependent applications, which are software applications that can run only on a particular type of computer/user device, machine-independent applications can run on a variety of user devices. The machine-independent applications that the developers create for execution on the user devices are also known as user apps.

Software development platforms are applications running on host systems that enable software developers to build and test the user apps on the host system before installing and executing the user apps on the user devices.

Software development platforms typically use a combination of software libraries and other executables that present well-defined Application Programming Interfaces (“API”) to software developers for creating and testing the user apps. Modern software development platforms typically include a programming language, the compiled output of which executes within the context of a runtime environment of the user devices. Modern user devices typically utilize machine-dependent programs known as virtual machines (“VM”) to implement the runtime environment on the user devices.

VMs permit an isolated processing environment to exist on a computer system. VMs run on top of an operating system of the computer system. VMs hide or abstract the details of the underlying computer system from software applications that execute within the context of the VMs, also referred to as “running on top of the VMs.” To create platform-independent applications, such as user apps, software developers use the software development platforms to compile the programming language source code of the user apps into a machine independent output format for execution on the VMs of the user devices. The machine independent output format is also known as bytecode.

Bytecode is typically a set of binary files that include platform-neutral instructions for implementing application behavior. The VMs interpret the bytecode, and execute corresponding native (e.g. machine-dependent) instructions on the target computer system/user device associated with the bytecode.

Examples of software development platforms include the Android, Java, and .NET platforms. Android is a registered trademark of Google, Inc. Google associates the Java trademark with its eponymous computer programming language, operating system, and related infrastructure and tools. In examples, runtime environments for Android include the Dalvik and ART VMs. Java is a registered trademark of Oracle Corporation. Oracle associates the Java trademark with its eponymous computer programming language, Java Virtual Machine (“JVM”) runtime environment, and related infrastructure and tools. .NET is a registered trademark of Microsoft, Inc.

Developers use the software development platforms to author the source code of the user apps. In the case of the Java programming language, the source code is included within class files. A Java compiler converts the source code for each Java class definition into its associated bytecode. For example, the Java compiler accepts a source file named “MyClass.java” with source code that includes the class definition for named class “MyClass,” converts the source code to bytecode, and stores the bytecode in class file “MyClass.class.”

Android is a mobile operating system for Android user devices. Android is a registered trademark of Google, Inc. and is based on the Linux kernel. User apps that extend the functionality of Android devices are developed primarily in the Java programming language.

In class-based object-oriented programming, a constructor in a class is a special type of subroutine or method that is called to create an object for the class. An object is a specific instance of a class. Constructors of a class prepare the new object for use, often accepting arguments to set and/or initialize required member variables of the class. A constructor resembles an instance method, but it differs from a method in that it has no explicit return type, it is not implicitly inherited and it usually has different rules for scope modifiers than instance methods. Constructors often have the same name as the declaring class. Constructors have the task of initializing an object's data members and of establishing the invariant of the class, failing if the invariant is invalid. A properly written constructor leaves the resulting object created for a class in a valid and deterministic state.

Redefinition of classes at runtime is a well-known practice. In Java, the HotSpot VM has provided the ability to redefine classes at runtime since JDK 1.4. This functionality is based on the work of Mikhail Dmitriev, from “Safe Class and Data Evolution in Large and Long-Lived Java Applications,” PhD thesis, University of Glasgow, 2001. This functionality is better known as HotSwap. In addition, a publication by Allan Raundahl Gregersen, “Extending NetBeans with Dynamic Update of Active Modules,” PhD thesis, University of Southern Denmark, 2010, discusses dynamic update of code modules using the NetBeans development platform. NetBeans is a registered trademark of Oracle, Inc.

Class loading refers to loading of class files for an application such as a user app on a target user device The class files are included within a file system of either the user app or of a desktop system, in examples. A class loader loads the class files for a user app when an instance of the user app is first created. Class reloading also involves loading of classes, but is associated with loading changes to the classes initially loaded by the class loader.

The classes loaded when the original instance of the user app is first created are also known as original classes. Typically, the original classes of a user app are maintained within a file system. The constructors within an original class are also known as original constructors.

Classes that include changes to the original classes are also known as changed classes. Changed classes can include new constructors, original constructors, and modified versions of the original constructors, also known as changed constructors. The changed classes are also maintained on a file system.

Class transformation is the process of modifying the bytecode of original classes and changed classes of an application. Class transformation is typically executed offline.

Class transformation of original classes is typically executed via a service running on the server system. Class transformation of changed classes is performed while an application instance has completed initializing and is currently executing.

Current software development platforms like Java support limited types of runtime class reloading in their VMs, such as that provided by HotSwap for the JVM runtime environment. Using HotSwap, a developer can create a new definition for a class file of a user app currently loaded in a currently running instance of the user app, and apply this new definition of the class file without having to stop and restart the instance of the user app on the user device to incorporate the new class definition. The new class definition is also known as a class redefinition.

The runtime class redefinition capability of HotSwap is limited. HotSwap supports the ability to perform runtime modification of the fields and methods of classes of a running user app. However, HotSwap does not support the ability to modify constructors of, nor add new constructors to, the classes of a running user app.

Current HotSwap implementations are built into stock versions of major JVMs, and only support changes to method bodies. However, an extended capability set has been proposed first by Mikhail Dmitriev, in the aforementioned reference, and later by Thomas Würthinger in “Dynamic code evolution for Java, PPPJ '10 Proceedings of the 8th International Conference on the Principles and Practice of Programming in Java.” The Dynamic Code Evolution VM (DCEVM) allows arbitrary changes to class definitions. Currently, the most widely used class reloading system is the JRebel system, an application-level system that enables runtime reloading of classes by utilizing bytecode re-writing at class load time. JRebel is a registered trademark of ZeroTurnaround USA, Inc. The JRebel system does support reloading of constructors in general for the Java Platform.

Spring Loaded is a class reloading system capable of reloading complex class changes including changes to constructors.

However, the successful reloading of changed constructors with JRebel or Spring Loaded requires that either HotSwap is available on the target platform, or that the bytecode verifier is turned off. On the Java Platform, HotSwap was added with the release of Java 5.0. For Java versions prior to Java 5.0, such as Java 4.0, developers running with JRebel have to specify a JVM command-line argument to turn off bytecode verification. In other words, constructor reloading for Java versions prior to Java 5.0 with current technologies such as JRebel or Spring Loaded is only possible by producing illegal bytecode.

On the Android platform, HotSwap is not implemented at all. Neither the Dalvik nor the ART VMs support runtime class redefinition. Moreover, turning off the bytecode verifier while developing applications such as user apps is not always possible, is cumbersome, and can lead to unforeseen issues when the user app later goes into production.

While the class reloading systems mentioned herein above target the Java platform, none of them works in an off-the-shelf manner on Android user devices. There is currently one approach that does target the Android Platform, namely InstaReloader, which allows runtime class reloading of Android applications. It supports a broad spectrum of changes at runtime, but does not support changes to constructors. InstaReloader is an application level approach to runtime class reloading, thus it is not a virtual machine. InstaReloader injects bytecode into application classes to support runtime class reloading.

### SUMMARY OF THE INVENTION

The present invention relates to the ability to dynamically redefine classes in a running Java application. More particularly, the present invention enables correct runtime behavior when constructors of original classes of a currently running instance of a user app on a user device are added or changed on a host system, and the classes including the additional constructors and the changed constructors are then sent to the user device and reloaded by a dynamic update. In response to the dynamic update, the running instance of the user app executes the functionality associated with the additional constructors and the changed constructors. In examples, changes to the constructors include when the arguments that are passed to the mandatory “super/this” constructor call in an original constructor have been changed. The method not only does not require runtime class redefinition capabilities like Java HotSwap, but also does not require disabling the standard Java bytecode verification feature.

In a preferred embodiment, the invention supports runtime class redefinition of classes of user apps running on Android user devices, where the redefined versions of the classes include additional constructors and/or changed constructors of the classes of the currently running user apps.

In general, according to one aspect, the invention features a method for updating a user app running within an Android virtual machine on a user device. The method comprises creating helper classes for changed classes of the user app, where the changed classes includes changed and/or new constructors, and the user app reloading the helper classes on the user device. Preferably, the helper classes are created on a host system, and the host system sends the helper classes to the user device.

The method further comprises creating transformed classes for original classes of the user app, wherein the original classes include original constructors, and the user app reloading the transformed classes on the user device along with the helper classes.

In one implementation, creating the transformed classes comprises providing identifiers for the original constructors; and transforming bytecode of the original classes into the transformed classes based on the identifiers. Preferably, creating the transformed classes comprises transforming bytecode of the original constructors of the original classes into transformed constructors based on the identifiers, and generating bytecode for a selector constructor within each of the transformed classes. The selector constructor enables runtime selection of most recent versions of the transformed constructors for each of the transformed classes, and enables runtime selection of most recent versions of the changed and/or new constructors for each of the changed classes.

In addition, the selector constructor enables runtime invocation of most recent mandatory constructor calls and runtime invocation of most recent constructor bodies of the transformed classes based on the identifiers.

In another implementation, creating the helper classes of the user app comprises providing identifiers for the changed and/or new constructors, and transforming bytecode of the changed classes into the helper classes based on the identifiers. Preferably, transforming bytecode of the changed classes into the helper classes comprises transforming bytecode of each changed and/or new constructor of the changed classes into a set of functionally equivalent static methods for each changed and/or new constructor based on the identifiers.

In examples, the user app can run within a Dalvik Android virtual machine of the user device or within an ART Android virtual machine of the user device.

In general, according to another aspect, the invention features a system for updating a user app. The system includes a user device running the user app within an Android virtual machine of the user device, and a host system. The host system creates helper classes for changed classes of the user app, where the changed classes include changed and/or new constructors. The host system then sends the helper classes to the user app, which reloads the helper classes on the user device. Typically, the user device includes a class reload system that enables the user app to reload the helper classes.

In general, according to yet another aspect, the invention features a method for updating a user app running within a virtual machine on a user device, wherein the virtual machine lacks runtime class redefinition support. The method comprises creating helper classes for changed classes of the user app, where the changed classes includes changed and/or new constructors, and the user app reloading the helper classes on the user device. In examples, virtual machines lacking runtime class redefinition support include the Dalvik and ART VMs, and Java Virtual Machine releases prior to Java 5.0, such as Java 4.0.

The above and other features of the invention including various novel details of construction and combinations of parts, and other advantages, will now be more particularly described with reference to the accompanying drawings and pointed out in any claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1A is a schematic diagram showing a preferred embodiment of a user app deployment system including a service module application (“service module”) running on a host system, where a file system of the host system hosts classes of a user app, and where the service module enables correct runtime behavior of the user app in response to a class reloading event that includes additions or changes to constructors of the user app's original classes;

FIG. 1B is a schematic diagram showing another embodiment of the user app deployment system, where the service module of the system is implemented as a Java agent within a user app of the user device, and where a file system of the user device hosts the classes of the user app;

FIG. 2 is a schematic block diagram of a constructor cache of the service module that includes unique constructor entries created for each constructor of every loaded or reloaded class of a user app;

FIG. 3A-3D are flowcharts that describe a method for the preferred embodiment of the user app deployment system in FIG. 1A, where FIG. 3A describes a method for transforming original classes and changed classes of a user app, FIG. 3B provides detail for creating versioned helper classes for transforming of changed classes in the method of FIG. 3A, FIG. 3C provides detail for generating bytecode of a selector constructor in the method of FIG. 3A, and FIG. 3D provides more detail for creating portions of the selector constructor in the method of FIG. 3C;

FIGS. 4A and 4B include Java source code of exemplary original classes A and B, respectfully, where the example original classes are used to illustrate the method of FIG. 3A;

FIG. 5 includes an example snippet of source code of a Java client of the user app that causes a class loading event, where the class loading event triggers loading of the original classes A and B of FIGS. 4A and 4B;

FIGS. 6A and 6B include Java pseudocode of example utility classes, where the pseudocode represents the bytecode of the utility classes, and where the service module uses the utility classes when loading and transforming the original and changed classes of the user app;

FIG. 6C-6G include flowcharts for the execution of the example utility classes in FIGS. 6A and 6B, the execution of which are triggered when selector methods in reloaded classes are selected;

FIGS. 7A and 7B include Java pseudocode of transformed classes A and B, where transformed classes A and B were created by applying the method of FIG. 3A to transform the bytecode of original classes A and B of FIGS. 4A and 4B;

FIGS. 8A and 8B include Java source code of exemplary changed classes A and B that include changes to original classes A and B, respectfully;

FIG. 9A shows example constructor entries that the method of FIG. 3A creates within the constructor cache in response to processing the original classes A and B of FIGS. 4A and 4B;

FIG. 9B shows example constructor entries that the method of FIG. 3A creates in the constructor cache in response to processing the changed classes A and B of FIGS. 8A and 8B;

FIGS. 10A and 10B include Java pseudocode of versioned helper classes A and B, respectively, where versioned helper classes A and B were created by applying the method of FIG. 3A to transform the bytecode of changed classes A and B of FIGS. 8A and 8B; and

FIG. 11 includes an example snippet of source code of a Java client that causes a class reloading event, where the class reloading event triggers loading of the changed classes A and B of FIGS. 8A and 8B.

### DETAILED DESCRIPTION OF THE PREFERRED EMBODIMENTS

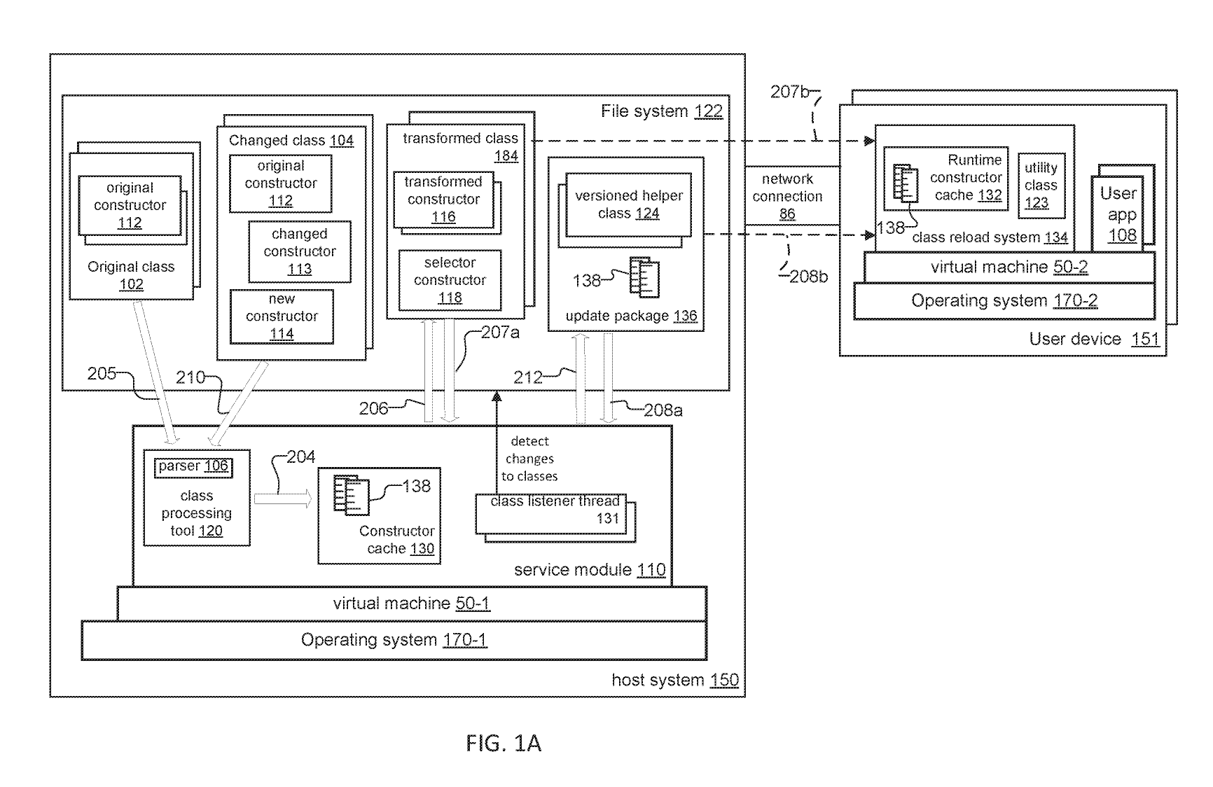

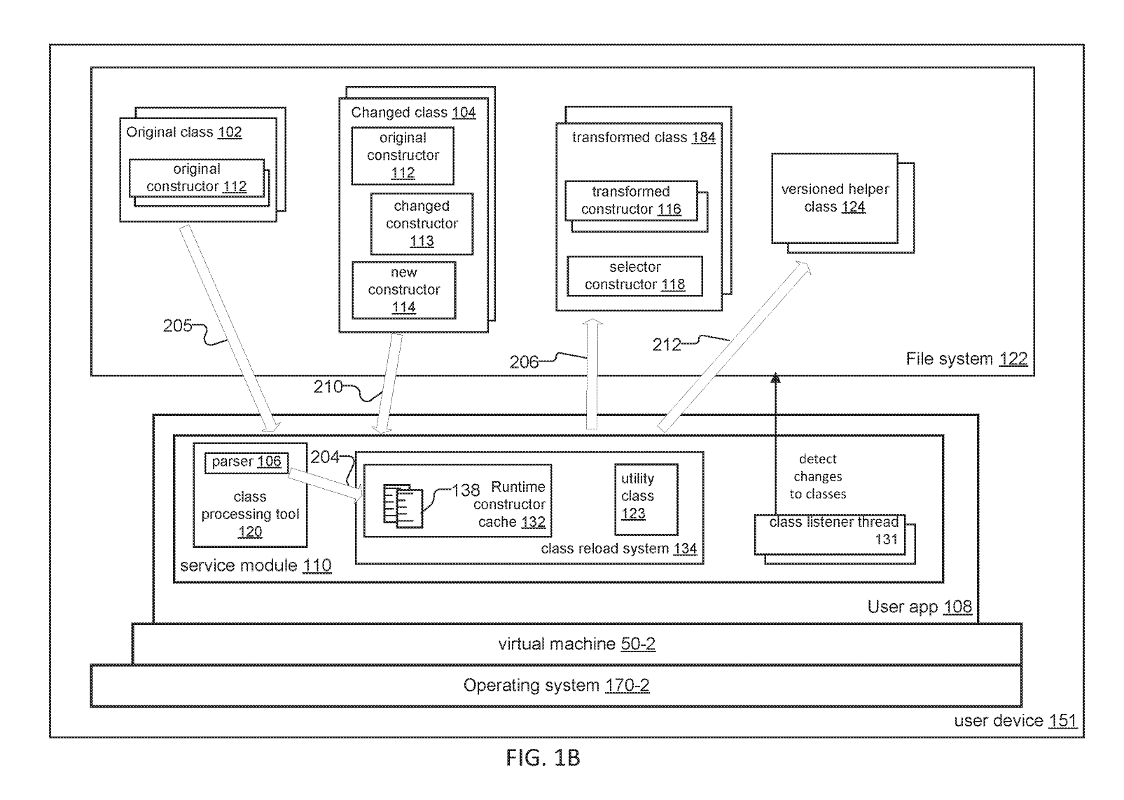

FIG. 1A is a schematic block diagram showing an exemplary host system 150 that provides hosting of classes for user apps 108. The user apps 108 run on user devices 151.

The host system 150 includes an operating system 170-1, a file system 122, and a virtual machine 50-1. The host system 150 also includes a service module desktop application (“service module”) 110. The service module 110 enables reloading of classes including constructors for a user app 108 running on a user device 151.

The user device 151 includes an operating system 170-2 and a virtual machine 50-2. User apps 108 and other applications on the user device 151 execute within the context of virtual machine 50-2, also referred to as running “on top of” the virtual machine 50-2. Applications other than the user apps 108 include a class reload system 134 In one example, the operating system 170-2 is Android.

The class reload system 134 includes a runtime constructor cache 132. The runtime constructor cache 132 includes constructor entries 138. The class reloading system 134 also defines utility classes 123 that implement useful common functions.

The host system 150 includes a service module 110, a virtual machine 50-1, and an operating system 170-1. The service module 110 runs on top of the virtual machine 50-1 and the virtual machine 50-1 runs on top of the operating system 170-1. The host system 150 also includes a file system 122 that includes classes of the user app 108.

The file system 122 of the host system 150 includes original classes 102 and changed classes 104 of the user app 108. The classes include bytecode, and it is the bytecode of the original classes 102 and changed classes 104 that the service module 110 modifies (e.g. transforms) to enable the runtime reloading of changes to constructors/addition of new constructors for classes of a running user app 108. The original classes 102 include one or more original constructors 112. The changed classes 104 may include the original constructors 112, one or more modified versions of the original instructors, also known as changed constructors 113, and one or more new constructors 114. The changed constructors 113 typically retain the function signature of the original constructors 112 but include changes to the code bodies of the original constructors 112. The new constructors 114 correspond to constructors having different function signatures than the original constructors 112. Developers create the changed classes 104 on the host system 150 to change the behavior of the user app 108.

In one example, the original and changed classes 102/104 are Java classes, and the virtual machine 50-2 of the user device 151 is a Java Virtual Machine (JVM) 50-2. However, the bytecode format of the classes can also be a non-standard or proprietary format, as long as the VM 50-2 is also instrumented such that it capable of understanding and executing the associated bytecode format of the classes.

If the user apps 108 are Android-based, meaning that the user apps 108 execute on an Android operating system 170-2 of the user devices 151, the source code of the user apps 108 is typically Java-based and typically compiled to standard Java bytecode classes. In other examples, the source code of the user apps 108 can be Kotlin, Groovy, Scala or any other language having a compiler that produces Java bytecode classes. Using Android-specific tools, developers then convert the java bytecode to an Android-proprietary bytecode/class format called DEX. These classes then execute on an Android-specific virtual machine 50-2 such as “Dalvik” or “ART” on the user devices 151. It is these Android-specific classes that developers preferably create on the host system 150 and then send to the Android user device 151 to be loaded/reloaded by the user apps 108. For Android user apps 108 that execute on a Dalvik VM 170-2 on an Android user device 151, in one example, developers convert Java class files into DEX files on the host system 150.

The host system 150 and the user devices 151 communicate via a network connection 86. The user devices 151 receive the classes and other data sent by the host system 150 over the network connection 86. In examples, the network connection 86 is a wired USB connection, or wireless Bluetooth/WiFi connection.

The service module 110 includes a class processing tool 120, one or more class listener threads 131 and a constructor cache 130. The constructor cache 130 includes constructor entries 138. The class processing tool 120 includes a parser 106.

The class processing tool 120 preferably operates with standard Java classes and Java bytecode format. However, the class processing tool 120 can also process classes that were compiled in an Android-proprietary bytecode format, in another example.

On the Android platform, there is no Java Virtual Machine. Instead, Java classes are compiled into an Android-proprietary bytecode format and run on an Android-specific VM 50-2 on the user devices 151. Examples of Android-specific VMs 50-2 include Dalvik and Android Runtime (ART).

The file system 122 also includes transformed classes 184 and an update package 136. The service module 110 typically creates a transformed class 184 for each original class 102. Each of the transformed classes 184 includes one or more transformed constructors 116 and a selector constructor 118. The update package 136 includes one or more versioned helper classes 124 and includes constructor entries 138 obtained from the constructor cache 130.

The service module 110 processes (arrow 205) original classes 102 of/for a user app 108 by reading the bytecode of the original classes 102 from the file system 122 into the memory of the service module 110. The bytecode is represented in memory on the service module 110 as a byte array. Note that the service module 110 can process the original classes 102 before the user app 108 is running. The parser 106 of the service module 110 parses the bytecode of the original classes 102 and saves information (arrow 204) associated with each of the original constructors 112 within a constructor entry 138 in the constructor cache 130. The information saved to each constructor entry 138 includes a unique index associated with each constructor for each of the original classes 102.

The service module 110 then transforms the original classes 102 by modifying the bytecode of the original classes 102. The complete set of modified bytecode for each original class 102 is also known as a transformed class 184. The transformed classes 184 are the produced result (arrow 206) from processing of the original classes 112. To create the transformed classes 184, the service module 110 uses the parsed bytecode of the original classes 102 in conjunction with the constructor entries 138 of the constructor cache 130. The service module 110 saves the transformed classes 184 onto the file system 122. In another example, the service module 110 can maintain an in-memory representation of the processed classes instead of saving them to the file system 122.

The service module 110 then reads in the transformed classes 184 (arrow 207a), and sends them to the user device 151 (arrow 207b). In one example, the service module 110 starts the instance of the user app 108 with the set of transformed classes 184 and the set of constructor cache entries 138 that were produced from processing of the original classes 102.

In another example, the constructor cache entries 138 are sent with the set of transformed classes 184 during the initial startup of the user app 108. When the system 134 receives constructor cache entries 138 from the service module 110, the class reload system 134 copies the received constructor cache entries 138 into the runtime constructor cache 132. In yet another example, the constructor entries 138 are not sent to the class reload system with the transformed classes 184. Instead, the constructor entries 138 are sent with the first update package 136 that the service module 110 sends to the class reload system 134. The service module 110 then creates versioned helper classes 124 for each of the changed classes 104, and includes the versioned helper classes 124 along with relevant constructor cache entries 138 in an archive. This archive is also known as an update package 136. In one example, the archive is an Android Package File (APK).

To process the changed classes 104 into the versioned helper classes 124, in a preferred implementation, the class listener thread 131 of the service module 110 determine which classes have changed (and therefore which classes to process once the user app 108 is already running) by detecting changes to the classes on the file system 122. The class listener thread 131 automatically detects changes to the classes by identifying changes to time stamps of the classes. The class listener thread 131 then provide the names of the changed classes 104 to the class processing tool 120. In another implementation, the names of the changed classes 104 can be sent manually to the service module 110 via a command-line interface or Graphical User Interface (GUI) tool.

In response to detecting changes to any of the original class files 102 residing on the file system 122, the service module 110 reads in (arrow 210) the bytecode of the changed classes 104. The parser 106 of the service module 110 parses the bytecode of the changed classes 104 and saves information (arrow 204) associated with each of the changed constructors 113 and new constructors within a constructor entry 138 in the constructor cache 130.

One example of a changed constructor 113 is when a mandatory constructor call statement (MCC) of an original constructor 112 is modified. An MCC of a changed constructor 113 specifies a different super constructor to invoke than the super constructor specified by the MCC of the original constructor 112.

Via the class processing tool 120, the service module 110 uses the parsed bytecode of the changed classes 104 in conjunction with the constructor entries 138 of the constructor cache 130 to transform the bytecode of the changed classes 104 into a set of versioned helper classes 124. This is indicated by arrow 212. The service module 110 includes the versioned helper classes 124, and the set of constructor cache entries 138 not already synched from the constructor cache 130 to the runtime constructor cache 132, within an update package 136 and saves the update package to the file system 122.

The constructor cache 130 includes a master copy of all constructor entries 138 for the constructors of the classes for the user app 108. The service module 110 copies the constructor entries 138 from the constructor cache 130 into the runtime constructor cache 132 on the user device 151. This provides the utility classes 123 with the ability to lookup information associated with the constructors, which the utility classes then use to select the proper methods to invoke within the versioned helper classes 124.

The service module 110 preferably creates one versioned helper class 124 for each changed class 104. Each versioned helper class 124 includes bytecode for implementing the behavior of its associated changed class 104, including bytecode for each new constructor 114 and changed constructor 113 of each changed class 104. The service module 110 also creates the update packages 136. Each update package 136 includes one versioned helper class 124 for each changed class 104 and the constructor entries 138. When the classes use Java bytecode format, the update packages 136 include bytecode in Java bytecode format.

If the user apps 108 are Android-based, meaning that the user apps 108 execute on an Android VM 50-2 and operating system 170-2, the service module 110 utilizes Android-specific conversion tools to convert the java bytecode of the processed classes to Android-proprietary bytecode/class format. The service module 110 then includes classes having Android-specific bytecode format within the update packages 136.

The service module 110 then controls the class reloading by loading (208a) the update package 136 from the file system 122, and sending the update package (arrow 208b) to the class reload system 134 of the user app 108. The class reload system 134 then loads the bytecode of the versioned helper classes 124 in the update packages 136 into the user app 108 and effectuates the reload operation.

The class reloading system 134 also provides public interfaces that indicate if an original class 102 has been reloaded. The class reload system 134 determines that an original class 102 has been reloaded when the class reload system 134 receives an update package 136 for the original class.

On the user device 151, the class reloading system 134 uses the utility classes 123 at runtime when the code of selector constructors 118 are executed. The utility classes perform lookups of the constructor entries 138 in the runtime constructor cache 132 to obtain up-to-date information for the constructors of the classes. The utility classes 123 then use the updated constructor information to enable the execution of methods in versioned helper classes 124.

The class reload system 134 is able to communicate freely with the user app 108. During the bytecode transformation process, the service module 110 can inject bytecode, the code statements of which link the transformed classes 184 with classes declared by the class reload system 134 when the transformed classes 184 are loaded into the virtual machine 50-2.

FIG. 1B is a schematic block diagram showing a second embodiment of the service module 110, included within a user app 108 on a user device 151. The user device 151 includes a file system 122, an operating system 170-2 and a virtual machine 50-2. The user app 108 runs on top of virtual machine 50-2.

The service module 110 is included within the user app and is preferably implemented as a Java agent. This enables direct communication between the user app 108 and the service module 110 on the user device 151.

Unlike in FIG. 1A, there is only one “constructor cache,” the runtime constructor cache 132. Because the service module 110 resides in the same memory space as the user app 108, the service module 110 creates the constructor entries 138 directly within a runtime constructor cache 132. This enables all classes of the user app 108 and utility classes 123 to have direct access to the constructor entries 138.

As in the system of FIG. 1A, the service module 110 enables reloading of classes including constructors for the user app 108. Unlike the system of FIG. 1A, however, which hosts the classes of the user app 108 on an external computer system such as a host system 150, the user device 151 in FIG. 1B includes the classes for the user app 108 in a file system 122 of the user device 151.

The file system 122 also includes versioned helper classes 124 and transformed classes 184. Each of the transformed classes 184 includes one or more transformed constructors 116 and a selector constructor 118. The service module 110 includes a class reload system 134.

The service module 110 determines the class path for the user app 108. This enables the processing of original classes of the user app 108. Whenever a class loading event occurs within the virtual machine 50-2 on the user device 151, the service module 110 determines if the class loading event is for loading an original class 102.

If the service module 110 determines that a user app 108 class loading event is associated with an original class 102, the service module 110 processes (arrow 205) the bytecode of the original classes 102 of a user app 108. In the event that the service module 110 is implemented as a Java agent to intercept loading of the classes, arrow 205 also represents the byte array passed to the Java agent class loading hook (e.g. “-javaagent . . . ”). when the contents of the classes are passed in a byte array format to the java agent. The parser 106 of the service module 110 parses the bytecode of the original classes 102 and saves information (arrow 204) associated with each of the original constructors 112 within a constructor entry 138 in the runtime constructor cache 132. The information saved to each constructor entry 138 includes a unique index associated with each constructor for each of the original classes 102.

The service module 110 then further transforms the original classes 102 by modifying or transforming the bytecode of each original classes 102 into bytecode of an associated transformed class 184. To create the transformed classes 184, the service module 110 uses the parsed bytecode of the original classes 102 in conjunction with the constructor entries 138 of the runtime constructor cache 132. The service module 110 saves the transformed classes 184 as a new byte array.

The service module 110 then passes the byte array for the transformed class 184 to the virtual machine 50-2, which in turn defines the transformed class 184 into the native code of the virtual machine 50-2.

In response to detecting changes to any of the original class files 102 residing on the file system 122, the changes of which are included in associated changed classes 104, the service module 110 reads (arrow 210) the bytecode of the changed classes 104. The parser 106 of the service module 110 parses the bytecode of the changed classes 104 and saves information (arrow 204) associated with each of the changed constructors 113 and new constructors 114 within a constructor entry 138 in the runtime constructor cache 132. The service module 110 updates existing constructor entries 138 in the constructor cache 130 with the information from the changed constructors 133, and adds a new constructor entry 138 for each new constructor 114. The information saved to the updated or new constructor entries 138 includes a unique index associated with each changed or new constructor for each of the changed classes 104.

Using the class processing tool 120, the service module 110 transforms (arrow 212) the bytecode of changed classes 104 into a set of versioned helper classes 124. To create the versioned helper classes 124, the service module 110 uses the parsed bytecode of the changed classes 104 in conjunction with the constructor entries 138 of the runtime constructor cache 132.

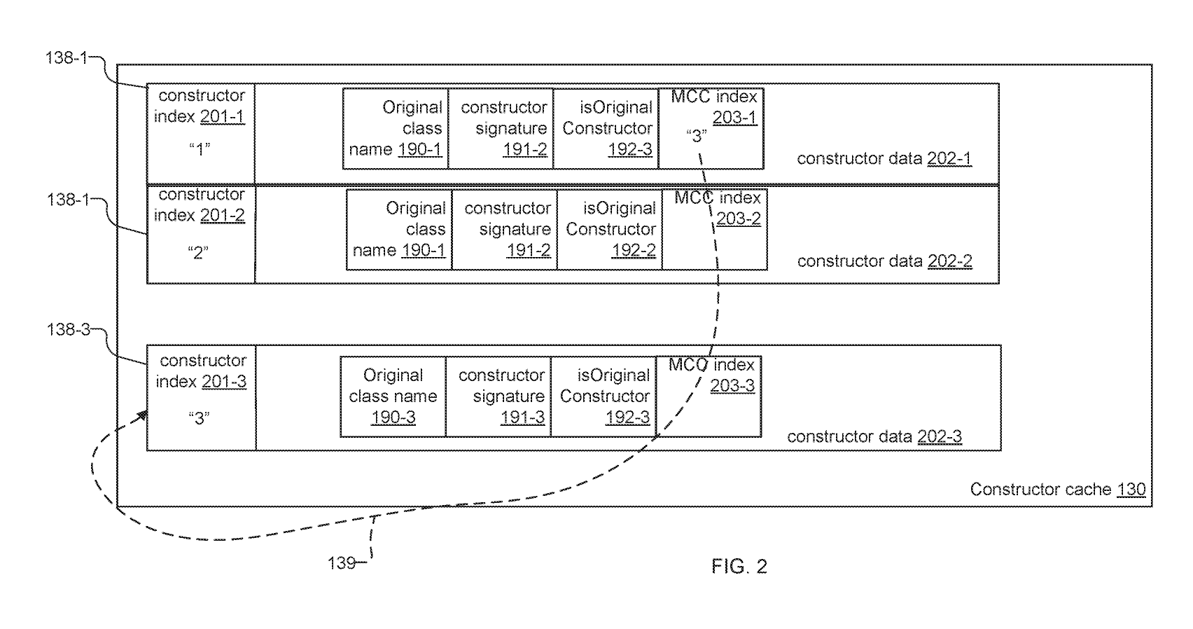

FIG. 2 shows a constructor cache 130 of FIG. 1A that includes constructor entries 138. Three example constructor entries 138-1, 138-2 and 138-3 are shown. Each constructor entry 138 includes a constructor index field 201 and a constructor data field 202. The value of the constructor index field 201 is unique across all constructor entries 138.

In general, when processing any classes of the user app 108, the service module 110 identifies each constructor of each class, and creates a constructor entry 138 with a unique constructor index 201 for each constructor within the current class. The service module 110 stores information for each constructor within its associated constructor entry 138 in the constructor cache 130. The service module 110 uses the constructor entries 138 to keep track of the versions of all constructors of all classes ever loaded (or reloaded) for each instance of a user app 108 on a user device 151.

The constructor data 202 includes the original class name 190 that declares the constructor, the constructor signature 191, a Boolean value, isOriginalConstructor 192, and one or more mandatory constructor call (MCC) indices 203.

Typically, the uniqueness of the constructor indices 201 for each constructor entry 138 is ensured by combining multiple different values to create the indices 201. In one implementation, the constructor indices 201 are calculated by combining the identifier (id) of the class loader that loads the class declaring the constructor, the original class name 190 that declares the constructor, and the signature of the constructor 191.

Exemplary values “1,” “2,” and “3” for constructor indices 201-1, 201-2, and 201-3, respectively, are shown. This allows each of the associated constructor entries 138-1, 138-2, 138-3 to be uniquely searched or “looked up” within the constructor cache 130.

Each MCC index 203 refers to a constructor entry 138 in the constructor cache 130. This is indicated by reference 139. Specifically, the value of each MCC index 203 corresponds to the value of the constructor index 201 of an associated constructor entry 138. For example, with respect to reference 139, MCC index 203-1 value “1” indicates that the constructor for constructor entry 138-1 includes an MCC. The constructor that the MCC statement invokes is represented by constructor entry 138-3.

The value of isOriginalConstructor 192 indicates whether the constructor is an original constructor 112 or a new constructor 114.

The constructor cache 130 includes one constructor cache entry 138 for each original constructor 112 and new constructor 114. When an original constructor 112 has been changed (e.g. the MCC within the constructor now references a different super constructor to invoke), the service module 110 updates the value of the MCC index 203 of the original constructor 112 to “point” to the constructor index 201 for the different super constructor. Note that the service module 110 does not create unique constructor cache 130 entries for changed constructors 113. Instead, the service module 110 updates the contents of an existing constructor cache 130 entry in response to detecting changes to the constructor associated with the constructor cache 130 entry.

Storing unique constructor cache entries 138 for each constructor, and maintaining up-to-date information about MCCs within each constructor, is a preferred implementation within the service module 110 to uniquely identify all constructors of all classes loaded by a user app 108 and to identify how the constructors are chained together by the MCCs. Using the constructor cache entries 138, the service module 110 can reconstruct the constructor call hierarchy of all loaded and reloaded constructors of a running user app 108. In this way, the service module 110 can provide deterministic runtime behavior of the user apps 108 in the presence of runtime class reloading of the user app's classes, when the reloaded classes include changes to the original versions of the constructors and new constructors, in examples. It can be appreciated, however, that there can be other implementations.

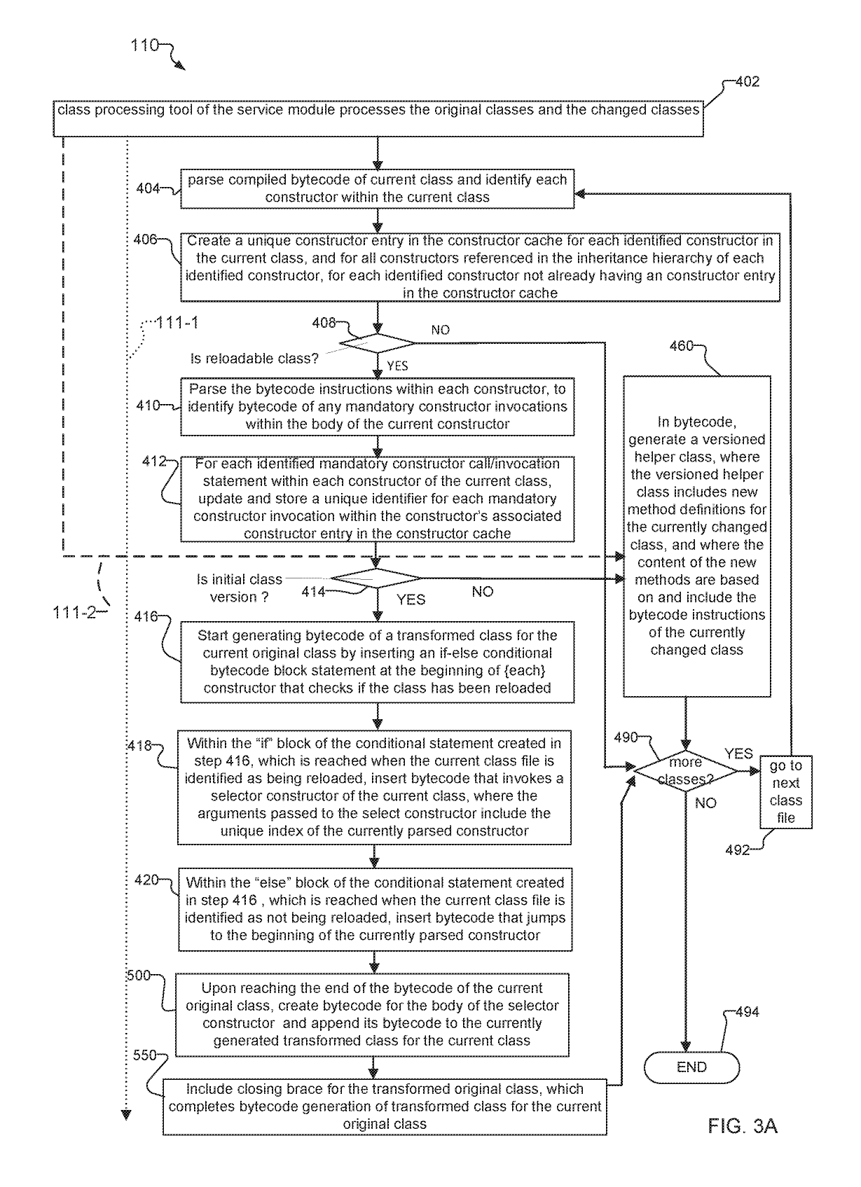

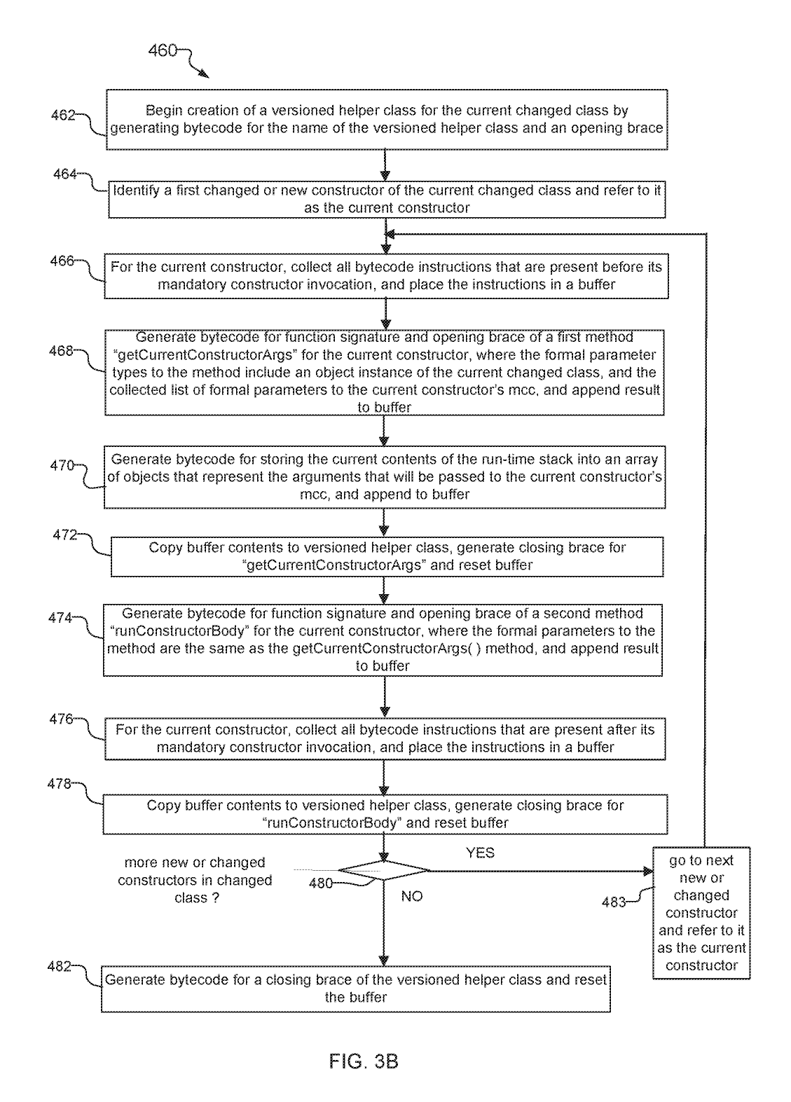

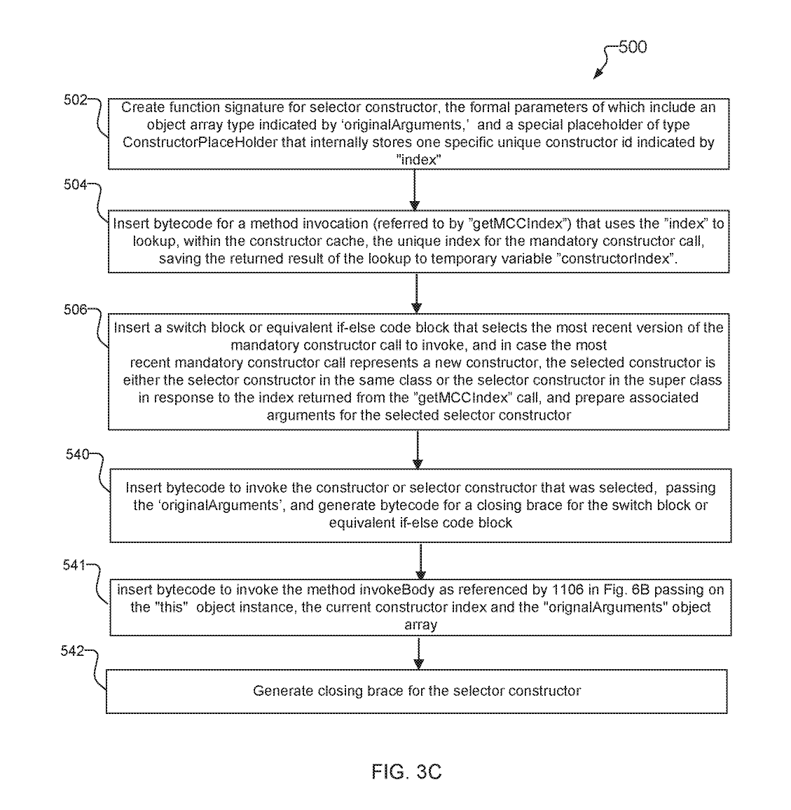

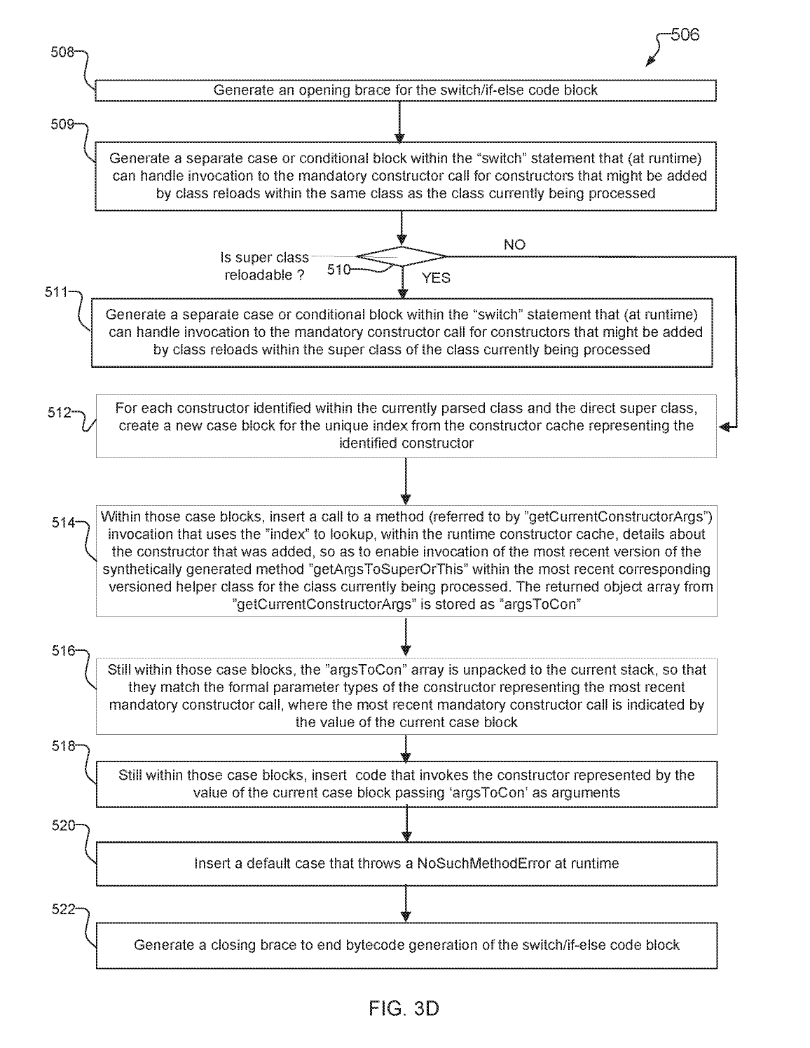

FIG. 3A is a flowchart for a class transformation method of the service module 110. The method transforms original classes 112 and changed classes 104 of a user app 108.

When processing the classes, the method executes different code paths. The method executes code path 111-1 when processing original classes 102 and executes code path 111-2 when processing changed classes 104. Note that code paths 111-1 and 111-2 both initially traverse steps 402 through 414, and then diverge thereafter.

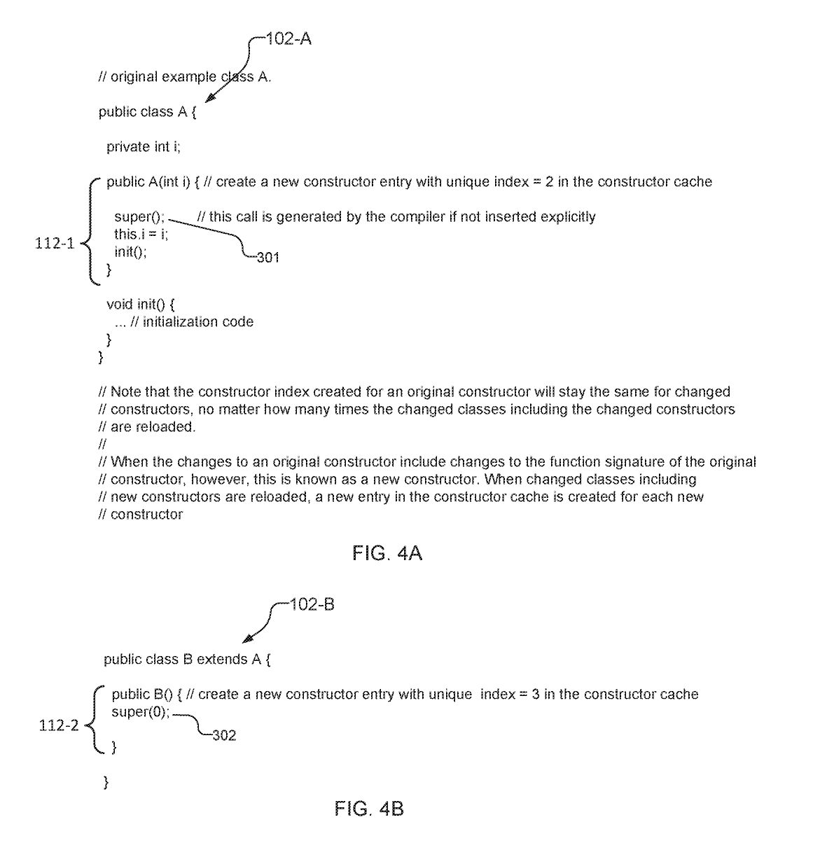

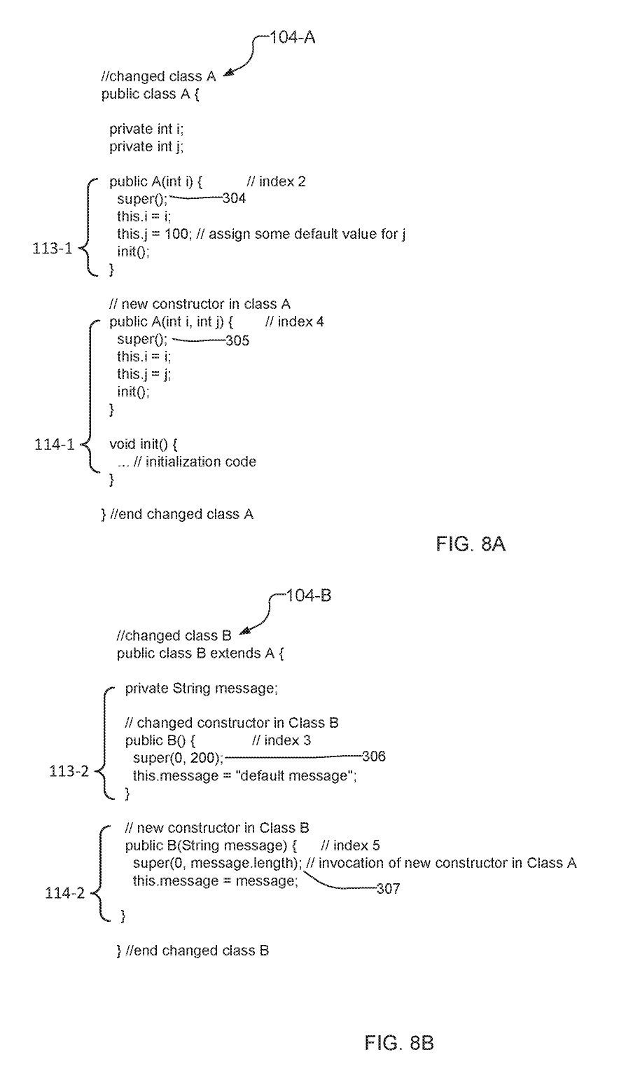

To illustrate the bytecode transformation that the service module 110 executes on the original and changed classes 102/104, the method of FIG. 3A is first described in conjunction with processing of example original class 102-A of FIG. 4A and example original class 102-B of FIG. 4B. Then, the method of FIG. 3A is described in conjunction with processing of changed class 104-A of FIG. 8A and changed class 104-B of FIG. 8B. The processing examples for original classes 102 and changed classes 104, included herein below, are in accordance with the preferred embodiment of the service module 110 in FIG. 1A. Preferably, the operating system 170-2 of the user device 151 is Android.

Processing of Original Classes: Applying the Method of FIG. 3A to Original Class A (102-A) of FIG. 4A and to Original Class B (102-B) of FIG. 4B

FIG. 4A and FIG. 4B include Java source code of original classes 102-A and 102-B, respectively. Original class 102-A has one original constructor 112-1. Original class 102-B has one original constructor 112-2.

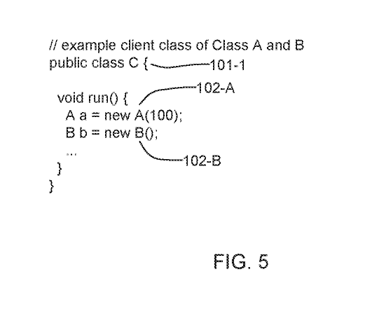

FIG. 5 shows source code of a Java client class “C” 101-1 of user app 108. Client class “C” 101-1 includes code statements that would create an instance of original class A (102-A) and original class B (102-B) on a user device 151. In FIG. 5, when the user app 108 executes the run( ) method of class “C” 101-1, instances of original classes 102-A and 102-B are created. In response to creation of instances of original classes 102-A and 102-B, a Java class loader begins to load original classes 102-A and 102-B into the virtual machine 50-2.

Returning to FIG. 3A, in step 402, the class processing tool 120 of the service module 110 processes the original classes 102-A and 102-B of FIGS. 4A and 4B, respectfully. The class processing tool 120 finds the original classes 102-A/102-B from the file system 122 by looking up the Android project class path of the user app 108. The project class path is passed to the service module 110 as a startup argument.

In step 404, the parser 106 parses the compiled bytecode of the current class, and identifies each constructor within the current class. With respect to the example original classes 102-A and 102-B, the parser 106 identifies original constructor 112-1 of original class 102-A and original constructor 112-2 of original class 102-B.

In step 406, the service module 110 creates a unique constructor entry 138 in the constructor cache 130 for each identified constructor in the current class, and for all constructors referenced in the inheritance hierarchy of each identified constructor, unless the identified constructor already has a constructor entry 138 in the constructor cache 130.

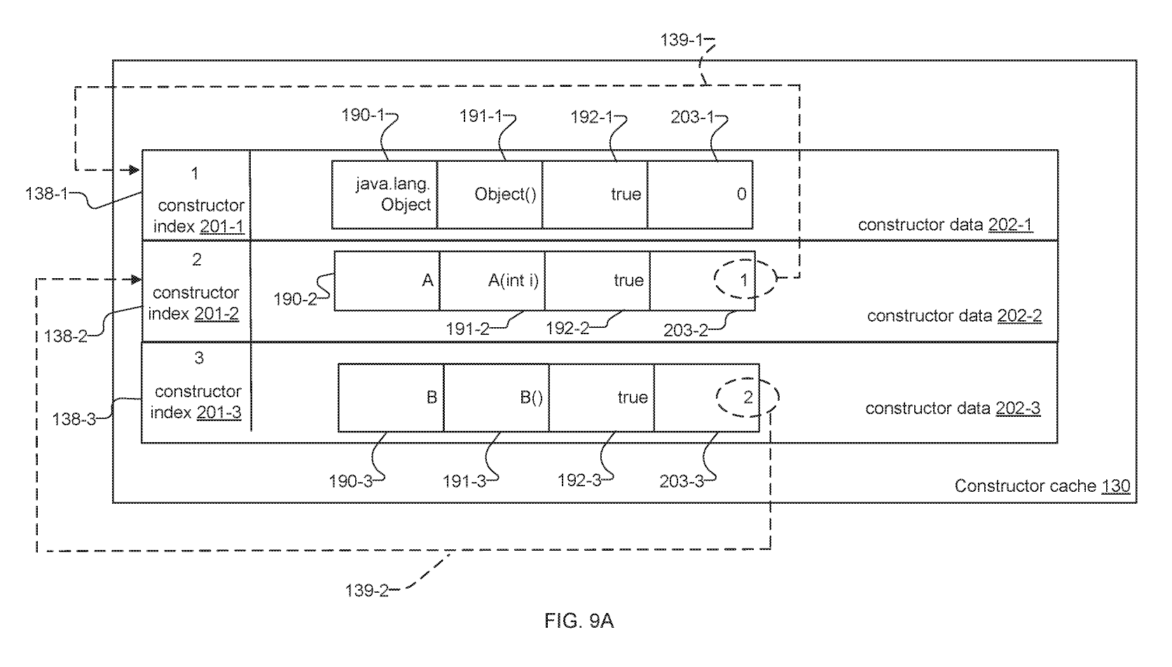

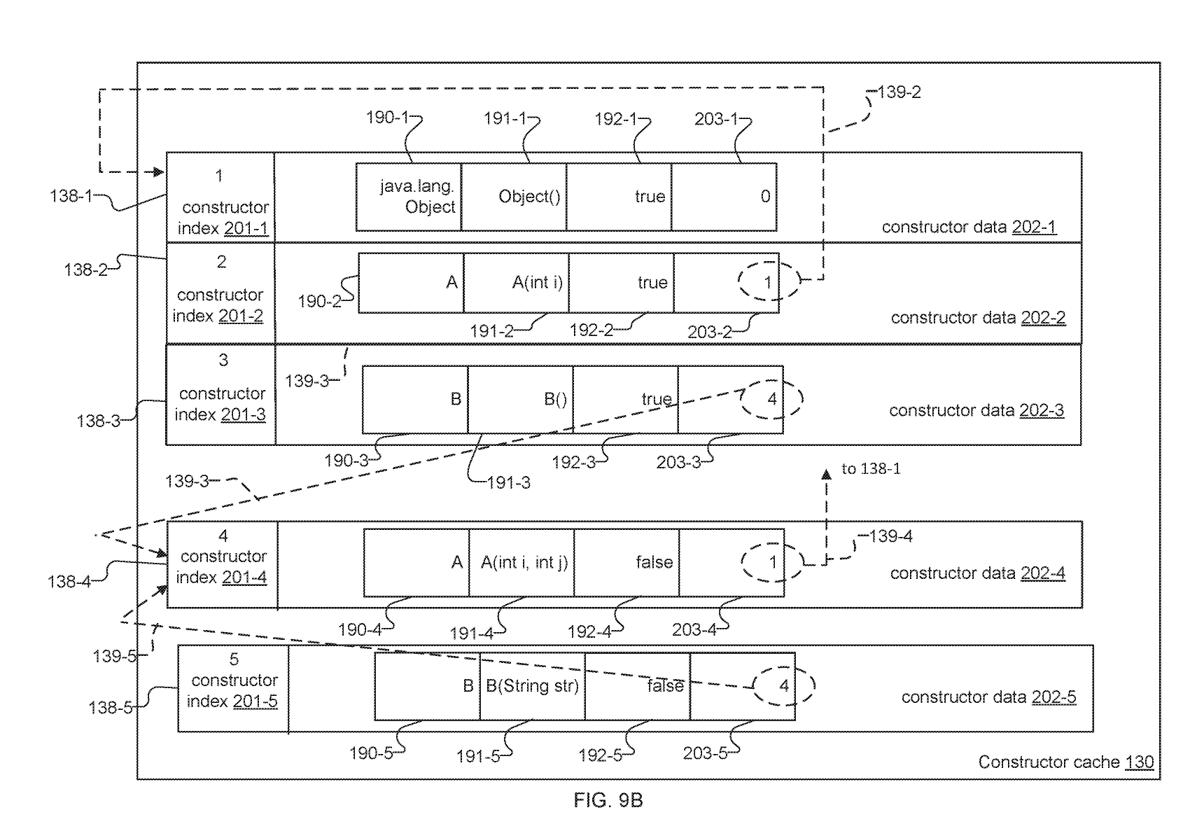

FIG. 9A shows example constructor entries 138 that the method of FIG. 3A creates in the constructor cache 130 in response to parsing changed classes 104-A and 104-B. In general, the values of the data fields use specific values where required, but otherwise use exemplary simplified values. For example, values of indices associated with creation of constructor entries 138, such as the constructor indices 201, were chosen to use simple, monotonically-increasing unique integer values.

When processing example original class 102-A, the parser 106 identifies one constructor, 112-1. Then, the parser 106 identifies one constructor within the call hierarchy of constructor 112-1, an implied constructor that invokes the super class of the original class 102-A. The super class is implicitly “java.lang.Object.” This is because no super class is explicitly stated in the class definition of class 102-A (e.g. the Java “extends” keyword does not specify the name of another class which class A “extends.”) For the implicit super( ) constructor, the parser 106 creates the constructor entry 138-1 and writes a unique value “1” for constructor index 201-1. Then, the parser 106 creates constructor entry 138-2 for the actual identified constructor 112-1, and writes value “2” for its constructor index 201-2.

For constructor entry 138-1, the parser 106 creates constructor data 202-1 and initializes its data fields. Within constructor data 202-1, the parser 106 writes value “java.lang.Object” for the original class name field 190-1, and a no-argument value for the constructor signature 191-1.

When processing example original class 102-B, the parser 106 identifies one constructor, 112-2. Then, the parser 106 identifies one constructor within the call hierarchy of constructor 112-2, the constructor 112-1 of class 102-A. This is because class B (102-B) “extends” class A (102-A) in the class definition of class 102-A.

Because a constructor entry for constructor 112-1 already exists in the constructor cache 130, however, the parser 106 only creates constructor entry 138-3 for the actual identified constructor 112-2 for original class 102-B, and writes value “3” for its constructor index 201-3.

Returning to FIG. 3A, in step 408, the service module 110 determines if the current class is a reloadable class. If the class is not reloadable, the processing of the current class ends, and the method transitions to step 490 to search for more classes to process. Otherwise, the method transitions to step 410. Because example classes 102-A and 102-B are reloadable, the method transitions to step 410.

In step 410, the parser 106 parses the bytecode instructions within each constructor of the current class to identify the bytecode of any mandatory constructor calls/invocations (MCCs) within each constructor. In examples, mandatory constructor calls (e.g. invocations) are associated with Java “super( )” and “this( )” code statements. In FIG. 4A, constructor 112-1 of class 102-A has one mandatory constructor call 301, “super( ).” In FIG. 4B, original constructor 112-2 of class 102-B also has one mandatory constructor call 302, “super(0)”.

In step 412, for each identified MCC of any changed constructors 113, the service module 110 stores a unique identifier for each mandatory constructor call statement. The identifier for the MCC is stored within the constructor's associated constructor entry 138 in the constructor cache 130. Applying step 412 to the example original classes 102-A and 102-B, in FIG. 9A, the service module 110 first processes MCC 301 for original class 102-A. To represent MCC 301, the service module 110 writes value “1” to the MCC index 203-2 field of the constructor data 202-2 of constructor entry 138-2.

Then, because constructor entry 138-1 is associated with a non-reloadable class, java.lang.Object( ), the service module 110 writes value “0” to the MCC index 203-1 field of the constructor data 202-1 of constructor entry 138-1. Value 0 is a special “don't care” value for all constructor entries associated with non-reloadable classes. For this purpose, the service module 110 first processes MCC 302 for original class 102-B. To represent MCC 302, the service module 110 writes value “2” to the MCC index 203-3 field of the constructor data 202-3 of constructor entry 138-3.

It is important to note that value “1,” for MCC index 203-2, is the same as the value of the constructor index 201-1 for constructor entry 138-1. This is indicated by reference 139-1. In a similar fashion, value “2,” for MCC index 203-3, is the same as the value of the constructor index 201-2 for constructor entry 138-2. This is indicated by reference 139-3. This mapping between the constructors associated with constructor entries 138 and MCCs referenced within constructor entries provides the critical ability for the service module 110 to track all constructors of all versions of all classes ever loaded (or reloaded) on user apps 108. This is especially the case for user apps 108 running on top of the Android operating system 170-2 on a user device 151.

Returning to FIG. 3A, in step 414, the method determines if this an initial version (e.g. an original class 102) of the current class, or a new version of the class (e.g. a changed class 104). If the current class is an original class 102, the method transitions to step 416. Otherwise, the method transitions to step 460 to process the changed class 104.

With respect to the constructor entries 138 created for 102-A and 102-B, in FIG. 9A, because the example classes 102-A and 102-B are original classes 102, the service module 110 writes value “true” for both the “isOriginalConstructor( )” field 192-2 of constructor data 202-2 of constructor entry 138-2, and for the “isOriginalConstructor( )” field 192-3 of constructor data 202-3 of constructor entry 138-3. The service module 110 also writes value “true” for the “isOriginalConstructor( )” field 192-1 of constructor data 202-1 of constructor entry 138-1, for the Object class.

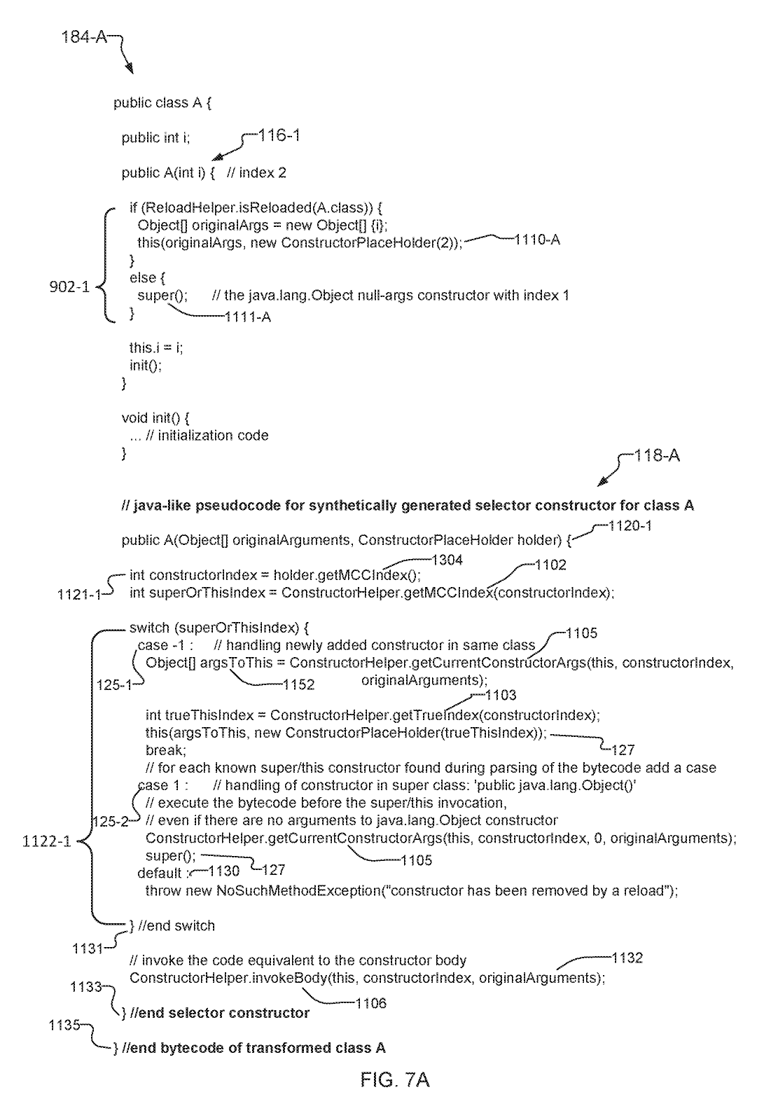

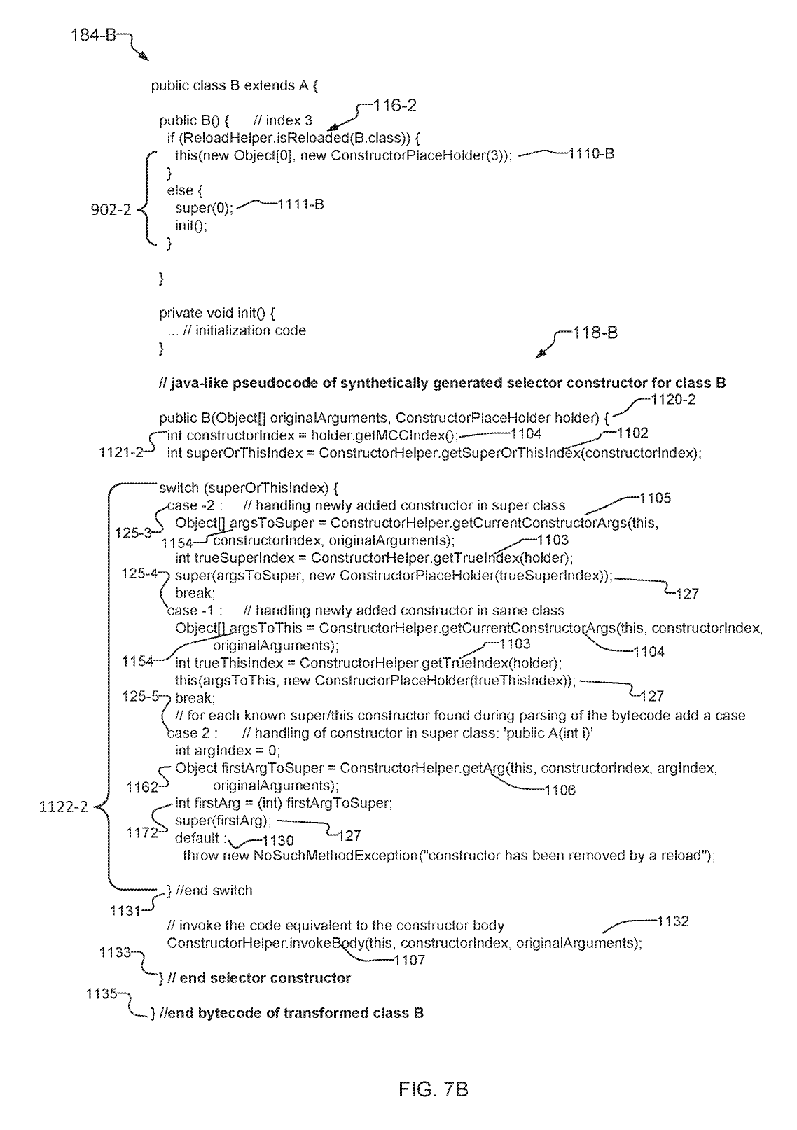

Returning to FIG. 3A step 414, because the example classes 102-A and 102-B are original classes 102, the method transitions to step 416 to begin generating bytecode of transformed class 184-A of FIG. 7A for original class 102-A, and to begin generating bytecode of transformed class 184-B of FIG. 7B for original class 102-B.

FIG. 7A includes Java pseudocode that represents the bytecode of the transformed class 184-A for original class 102-A. Transformed class 184-A includes transformed constructor 116-1 and selector constructor 118-A. In a similar vein, FIG. 7B includes Java pseudocode that represents the bytecode of transformed class B (184-B). Transformed class 184-B includes transformed constructor 116-2 and selector constructor 118-B. The remaining references within FIGS. 7A and 7B are described in conjunction with the remaining steps starting from block 416 of FIG. 3A, included herein below.

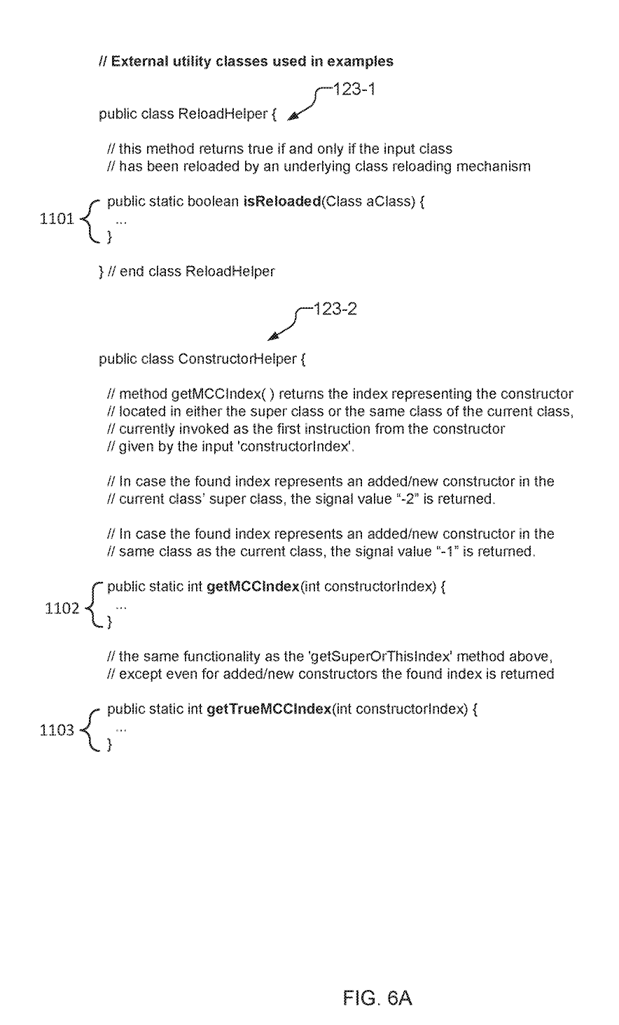

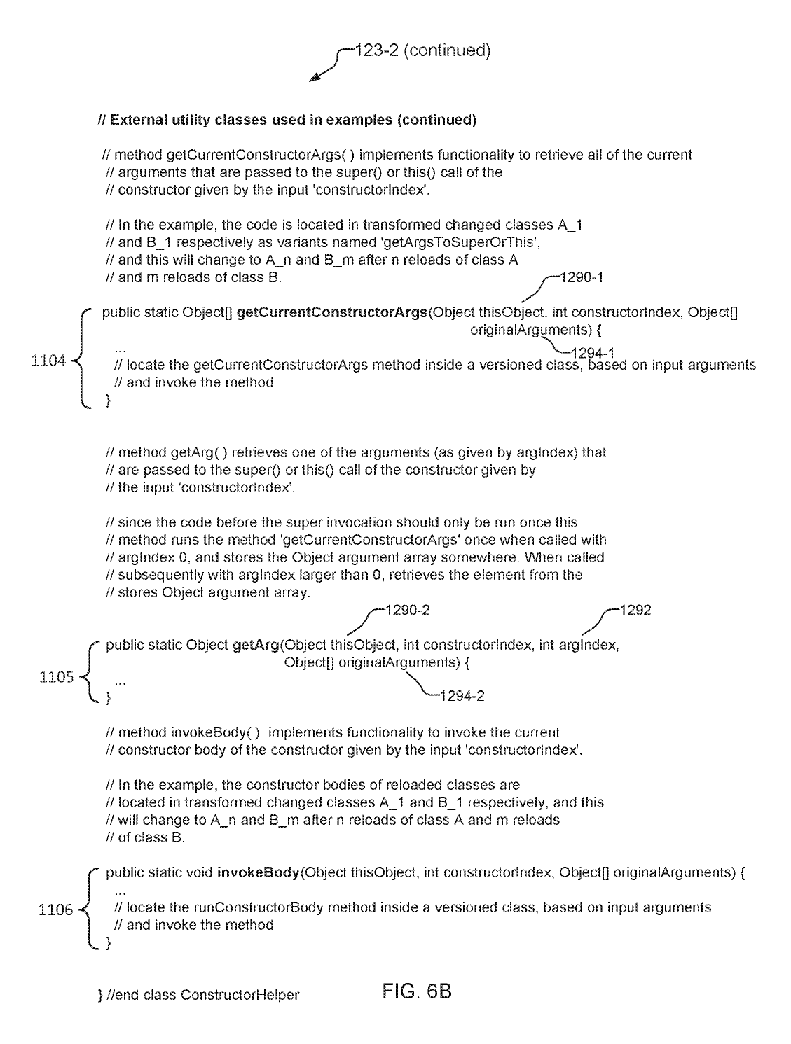

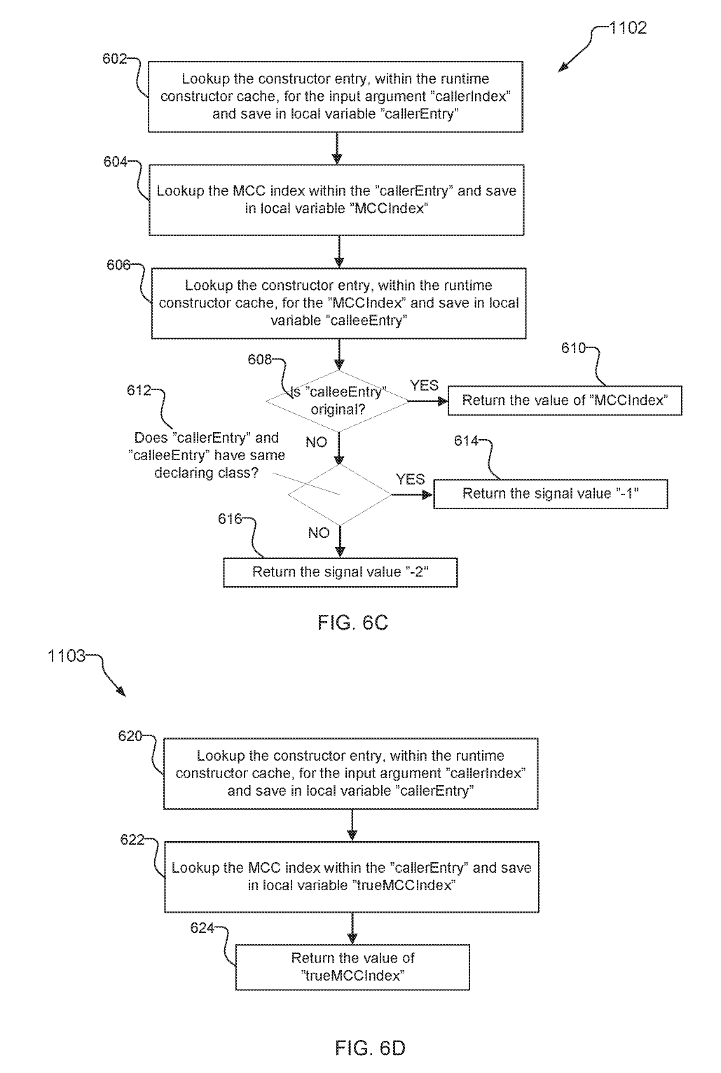

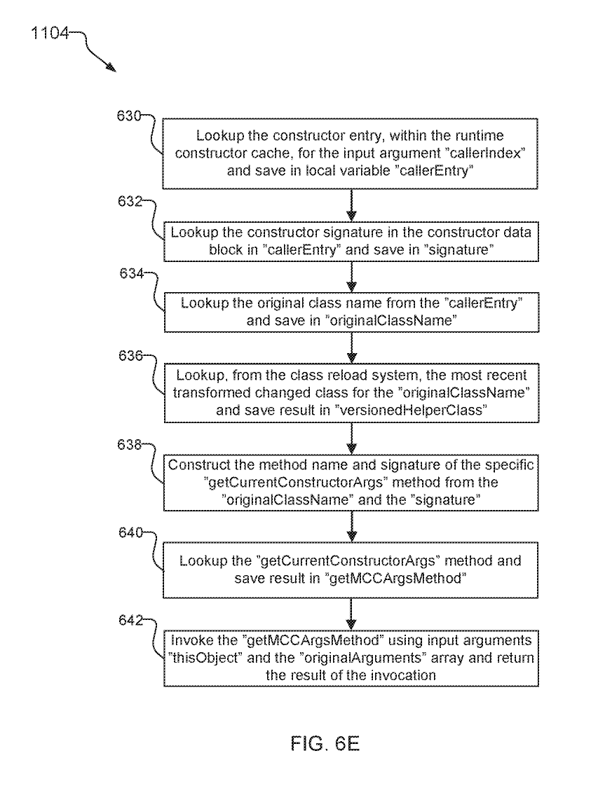

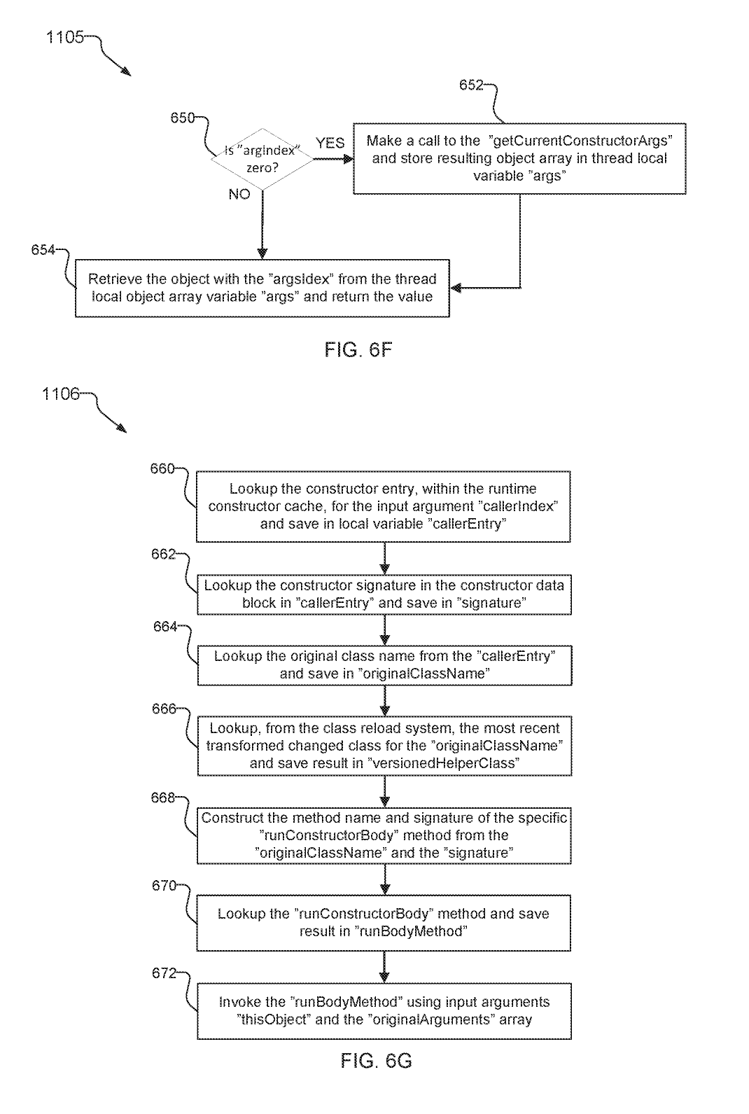

When generating the bytecode of the transformed classes 184-A and 184-B, the service module 110 utilizes the utility classes 123 of FIGS. 6A and 6B.

FIGS. 6A and 6B include Java pseudocode that represents the bytecode of utility classes 123. The disclosed content of utility classes 123 is intended to be illustrative rather than exhaustive with respect to the functions the utilities provide. Nonetheless, FIG. 6C-6G disclose example implementations of the key methods within the utility classes 123.

In FIGS. 6A and 6B, two high-level utility classes 123-1 and 123-2 are disclosed. Utility class 123-1 for class ReloadHelper includes one helper method isReloaded( ) 1101. Method isReloaded( ) 1101 returns true if the method determines that its input class argument has been reloaded by an underlying class reloading mechanism.

Utility class 123-2 for class ConstructorHelper includes five exemplary helper methods. The first helper method is getMCCIndex(int constructorIndex) 1102. This helper method returns the index representing the mandatory constructor call for the constructor with the input “constructorIndex.” Method getTrueMCCIndex( ) 1103 operates on changed constructors 113 and new constructors 114.

FIG. 6B includes the remainder of the contents of utility class 123-2. Method getCurrentConstructorArgs( ) 1104 implements functionality to retrieve all of the arguments that are passed to the mandatory constructor invocation super( ) or this( ) of the constructor pointed to by its input argument ‘constructorIndex’. The getCurrentConstructorArgs( ) 1104 operates by locating the getCurrentConstructorArgs method located within versioned classes 124 based on the input arguments.

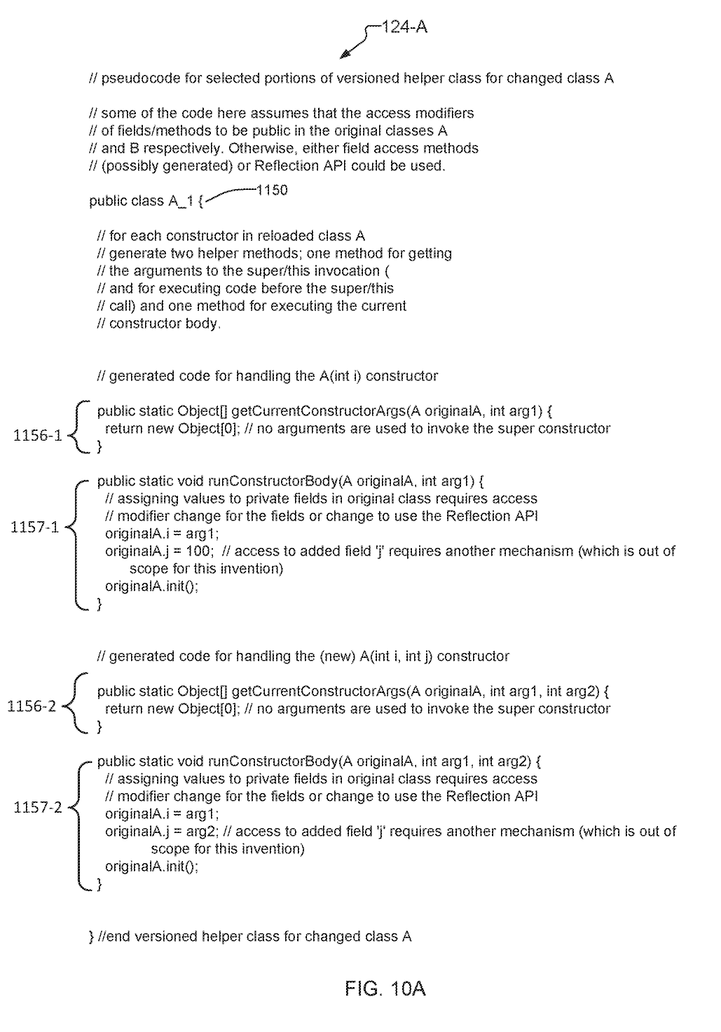

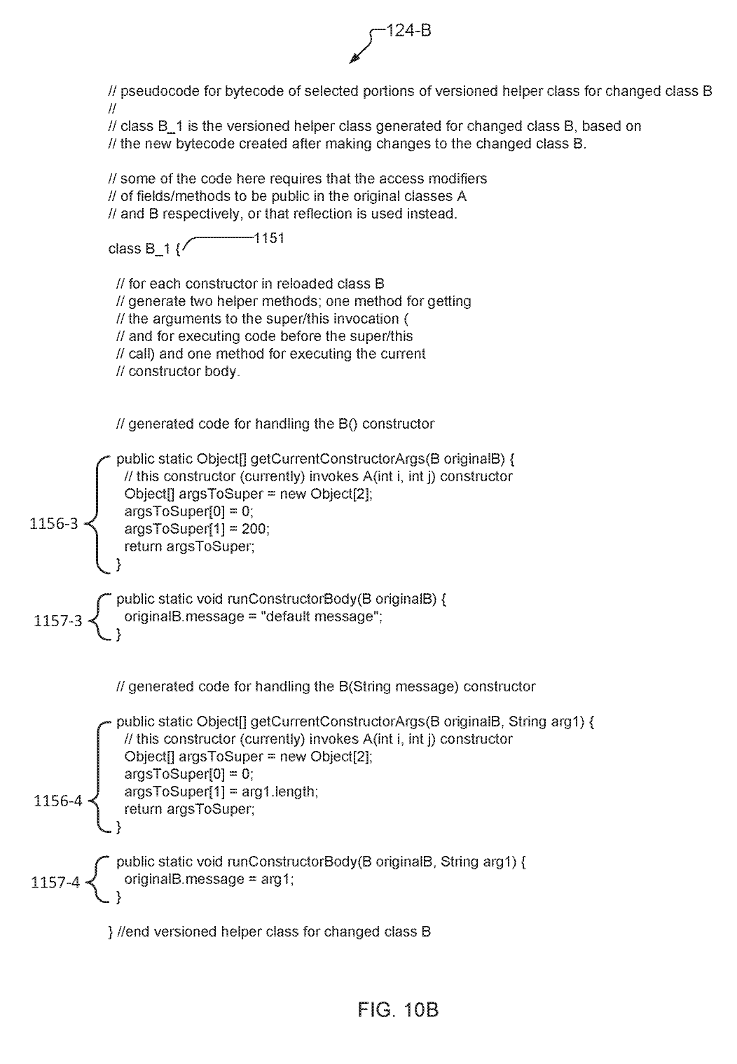

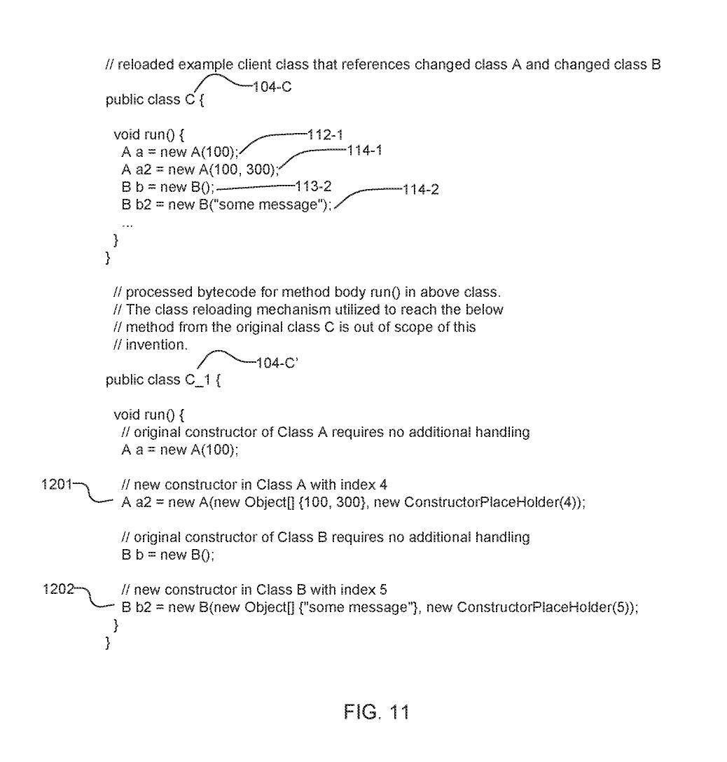

For the example versioned helper class A_1 124-A as shown in FIG. 10A, the getCurrentConstructorArgs method, which can be located and invoked by the utility class 123-2, is either one of the two methods referenced in FIG. 10A by 1156-1 and 1156-2 respectively. Method getArg( ) is referenced by label 1105. Finally, method invokeBody( ) is referenced by label 1106. The method invokeBody( ) 1104 operates by locating the runConstructorBody method located within versioned classes 124 based on the input arguments. For the example versioned helper class A_1 124-A as shown in FIG. 10A the runConstructorBody method which can be located and invoked by the utility class 123-2 is either one of the two methods referenced in FIG. 10A by 1157-1 and 1157-2 respectively.

Returning to FIG. 3A, in step 416, the method inserts an if-else conditional bytecode block statement at the beginning of each constructor. The conditional checks if the class has been reloaded. In FIGS. 7A and 7B, this is indicated by reference 902-1 in transformed class 184-A and reference 902-2 in transformed class 184-B.

In step 418, within the “if” block of the conditional statement created in step 416, insert bytecode that invokes a selector constructor 118 of the current class. The arguments passed to the selector constructor 118 include the unique index for the currently parsed constructor 112. In FIGS. 7A and 7B, this is indicated by reference 1110-A in transformed class 184-A and reference 1110-B in transformed class 184-B.

In step 420, within the “else” block of the conditional statement of step 416, which is reached at runtime on the user app 108 when there is no versioned class 124 for the currently executing class, the service module 110 inserts bytecode that jumps to the beginning of the currently parsed constructor. In FIGS. 7A and 7B, this is indicated by reference 1111-A in transformed class 184-A and reference 111I-B in transformed class 184-B.

In step 500, upon reaching the end of the bytecode of the current class, the service module 110 generates bytecode for the body of a selector constructor 118. The service module then appends the bytecode for the selector constructor 118 to the current transformed class 184. In FIGS. 7A and 7B, this is indicated by reference 118-A in transformed class 184-A and reference 118-B in transformed class 184-B.

FIG. 3C provides detail for FIG. 3A step 500.

In step 502, the service module 110 creates a function signature for the selector constructor 118. The formal parameters of the selector constructor 118 include an object array type indicated by ‘originalArguments,’ and a special placeholder of type ConstructorPlaceHolder that internally stores a specific unique constructor id, indicated by “index.” In FIGS. 7A and 7B, this is indicated by reference 1120-1 in selector constructor 118-A and by reference 1120-2 in selector constructor 118-B.

In step 504, the service module 110 inserts bytecode for a method invocation (“getMCCIndex”) indicated by reference 1102 in FIG. 6A.

In FIG. 6A, method getMCCIndex( ) 1102 uses the “index” at runtime to lookup, within the runtime constructor cache 132, the unique index for the mandatory constructor call, saving the returned result of the lookup to temporary variable “constructorIndex.” In FIGS. 7A and 7B, this is indicated by reference 1121-1 in selector constructor 118-A and by reference 1121-2 in selector constructor 118-B.

FIG. 6C provides details for the runtime execution flow of the “getMCCIndex” method 1102 of FIG. 6A. Step 602 is reached when entering the method “getMCCIndex.” Method getMCCIndex( ) is called from the selector constructor 118. This method looks up the constructor entry 138 within the runtime constructor cache 132 for the input argument “callerIndex.” The associated constructor entry 138 object returned from the lookup is saved to local variable “callerEntry”.

In step 604, a lookup of the MCC index 203 within the “callerEntry” constructor data 202 is performed. The constructor entry 138 pointed to by the MCC index 203 returned from the lookup is saved to local variable “MCCIndex”. According to step 606, the method looks up the constructor entry 138 for the saved “MCCIndex” within the runtime constructor cache 132. The constructor cache entry 138 returned from the lookup of the runtime constructor cache 132 is saved to local variable “calleeEntry”.

In step 608, which is a conditional block where the method checks whether the constructor data 202 of the “calleeEntry” is an original constructor 112. In that case the execution flow transitions to step 610, in which the already found “MCCIndex” is returned from the method. Returning to step 608, in case of a new constructor 114, a further conditional check is carried out by step 612, where the original class name data 190 within the constructor data 202 of the “callerEntry” and “calleeEntry” constructor entries 138 are checked for equality. In the “yes” branch from step 612, the method returns the special signal value (−1) in step 614, indicating that the MCC should currently be invoked to a new constructor 114 within the same class as the selector constructor 118 that called the “getMCCIndex”. In the “no” branch of step 612, the method carries on to step 616 where the special signal value (−2) is returned, indicating that the MCC should currently be invoked to a new constructor 114 within the super class of the class declaring the selector constructor 118 that called the “getMCCIndex”.

If the constructor index 201 initially found within the body of the “getMCCIndex” method 1102 corresponds to an entry within the constructor cache 130 that represents a new constructor 114, where the new constructor 114 was added by a previous class reload operation, method 1102 will return one of the two special signal values, (−1) or (−2). These signal values are used to specify to the selector constructor 118 that a direct call to the MCC, as referenced by 125-2 case “1” in FIG. 7A to the MCC, is not possible here. This is because constructors that are added by class reloads are not yet known to the service module 110 when applying FIG. 3C to original classes 102.

Hence, the service module 110 inserts bytecode for invoking either the same selector constructor 118 in the class or to the selector constructor 118 within the superclass. At runtime, when the special signal values (−1) or (−2) occur when the constructor selector 118 executes, the selector constructor 118 creates a new ConstructorPlaceHolder object with the “truelndex” as returned from the utility method getTrueMCCIndex( ). This is indicated by reference 1103 in FIG. 6A.

FIG. 6D provides details for the getTrueMCCIndex( ) method 1103 of FIG. 6A. Method getTrueMCCIndex( ) 1103 always returns the MCCIndex regardless of whether the constructors are original constructors 112, changed constructors 113 or new constructors 114.

In step 620, the getTrueMCCIndex method 1103 initiates execution by looking up the constructor cache entry 138, within the runtime constructor cache 132, for the input argument “callerIndex.” The constructor entry 138 object returned from the lookup is saved to local variable “callerEntry”.

In step 622, the MCC index 203 of the “callerEntry” is looked up from the constructor data 202 and saved to a local variable “trueMCCIndex”, which is then returned in step 624.

Returning to FIG. 3C step 540, the created ConstructorPlaceHolder object is then passed as argument along with the “argsToThis” or “argsToSuper” referred to in FIGS. 7A and 7B as references 1152 and 1154. In step 506, the service module 110 inserts a switch block or equivalent “if-else” code block that chooses the most recent version of the MCC to invoke, including the two special cases for calling the MCC through selector constructor for the special cases −1 and −2, in response to the index returned from the “getMCCIndex” call.

The service module 110 also inserts bytecode for preparing associated arguments, if any are required, for the chosen MCCs indicated by reference 301 and 302 in FIGS. 4A and 4B for original classes 102-A and 102-B. In FIGS. 7A and 7B, this is indicated by reference 1122-1 in selector constructor 118-A and by reference 1122-2 in selector constructor 118-B.

FIG. 3D provides detail for FIG. 3C step 506.

In step 508, the service module 110 generates an opening brace for the switch/if-else code block. In FIGS. 7A and 7B, this is indicated by reference 1123-1 in selector constructor 118-A and by reference 1123-2 in selector constructor 118-B. In step 509, the method generates a separate case or conditional block within the “switch” statement that (at runtime) can handle invocation to the mandatory constructor call for constructors that might be added by class reloads within the same class as the class currently being processed. This is indicated by reference 125-1 in selector constructor 118-A of FIG. 7A and by reference 125-4 in selector constructor 118-B of FIG. 7B.

In step 510, the service module 110 checks if the super class of the class being processed is also a reloadable class. In one example, non-reloadable classes are system classes such as java.lang. Object or any other class within the Java JDK library. In other examples, the set of non-reloadable classes besides the JDK core classes also contains classes within referenced third party libraries of the user app 108.

In the event the superclass is a reloadable class, the control transitions to step 511 in which the method generates a separate case or conditional block within the “switch” statement that (at runtime) can handle invocation to the mandatory constructor call for constructors that might be added by class reloads within the superclass as the class currently being processed. In FIG. 7B, this is indicated by 125-2 within selector constructor 118-B, which that allows the execution of the MCC for any new constructor that might be added to superclass A as indicated by changed class 104-A in FIG. 8A.

In step 510, when the superclass is not reloadable, the control immediately transitions to step 512, leaving out the construction of the separate case or conditional block that can handle new constructors in superclasses. Applying FIG. 3D to original class 102-A produces the selector constructor as indicated by 118-A in FIG. 7A, wherein no special case “case −2” 125-2 exists because the service module 110 has determined that the superclass, which is java.lang. Object for selector constructor 118-A, is not reloadable.

In step 512, for each constructor identified within the currently parsed class and the direct super class, create a new “case” block. The operand of the “case” block is the value of the constructor index 203 for the constructor's associated constructor entry 138 in the constructor cache 130.

These case blocks are added for all original constructors 112. The code statements within each case block will handle, at runtime, the MCC to the original constructors 112 in the class itself (i.e. all the this( ) calls with the class itself) as well as any original constructor in the super class (i.e. all the super( ) calls) regardless of the superclass being reloadable or non-reloadable. In FIGS. 7A and 7B, this is indicated by reference 125-2, “case 1” for selector constructor 118-A, and by reference 125-5, “case 2” for selector constructor 118-B.

In step 514, within those case blocks, insert bytecode for one or more method invocations (“getCurrentConstructorArgs” referred to by FIG. 7B in reference 1104), in a utility class 123, that at runtime uses the “index” to lookup, within the runtime constructor cache 132 details about the constructor that was added.

This enables the utility class 123 to locate the specific methods within versioned helper classes 124-A and 124-B, for which the arguments to the current MCC can be extracted by invocation of the most recent version of the synthetically generated method getCurrentConstructorArgs( ). This is indicated in FIGS. 10A and 10B by references 1156-1, 1156-2, 1156-3 and 1156-4. The arguments retrieved for the MCC for the special cases “case −1” and “case −2” are stored as “argsToThis” and “argToSuper” respectively. In FIGS. 7A and 7B, these are indicated by references 1152 and 1154, respectively.

FIG. 6E provides details for the getCurrentConstructorArgs( ) method 1104.

In step 630, the getCurrentConstructorArgs( ) method 1104 initiates execution by looking up the constructor entry 138, within the runtime constructor cache 132, for the input argument “callerIndex.” The constructor entry 138 object returned from the lookup is saved to local variable “callerEntry.”

Then, in step 632, the method looks up the constructor signature 191 from the constructor data 202 in the “callerEntry” and saves the result in a local variable “signature.”

In step 634, the method looks up the original class name 190, from the constructor data 202, within the “callerEntry” and saves the result in a local variable “originalClassName.”

In step 636, the method utilizes the class reload system 134 to lookup the most recent versioned helper class 124 for the “originalClassName” and stores the result of the lookup to local variable “versionedHelperClass.”

In step 638, the method constructs the method name and signature of the specific “getCurrentConstructorArgs” method, which is located in the versioned helper class 124, using the “originalClassName” and the “signature.”

Based on the constructed name and signature in the previous step, step 640 looks up the specific getCurrentConstructorArgs( ) method within the versioned helper class 124 and saves the result in a local variable “getMCCArgsMethod.” In one example, the lookup of the specific method is carried out by using the Reflection API of the Java platform.

In step 642, the method finally executes the “getMCCArgsMethod” using the input “thisObject” and the “originalArguments” array and returns the result of the invocation. The “thisObject” and “originalArguments” array is indicated in FIG. 6B as reference 1290-1 and 1294-1 respectively. Upon completion of step 642, execution of getCurrentConstructorArgs( ) method 1104 terminates, and control is passed back to FIG. 3D step 514.

Returning to FIG. 3D step 514, for all other cases for handling the MCCs for every original constructor, a number of method invocations are made, to a method getArg( ) 1105 corresponding to the number of formal parameters for the current MCC, to retrieve one by one the runtime arguments that should be passed on to the MCC. In FIG. 7B, this is indicated by reference 1105.

FIG. 6F provides details for an example implementation of the execution flow of the getArg( ) method 1105.

In step 650, the getArg method 1105, initiates execution by performing a conditional check if the input “arglndex” is zero or “0”. The “arglndex” is indicated in FIG. 6B as reference 1292.

Returning to FIG. 6F, step 652 carries out the “yes” branch of step 650 by making a call to the “getCurrentConstructorArgs” method 1104 and stores the resulting object array in a thread local variable “args”. A thread local variable means that the scope of the value is limited to the currently executing thread, so that if two or more simultaneous executions of the getArg methods are carried out by multiple thread, then each thread will see its own version of the variable.

In step 654, which is reached directly through both the “yes” branch of step 650 as well as from 652, then retrieves the object/value stores by the thread local “args” value at the index given by the “argslndex” input value.

Returning to FIG. 3D step 514, the returned arguments from the method invocations to “getCurrentConstructorArgs( )” is stored as “firstArg,” “secondArg,” “thirdArg,” etc. In example, in FIG. 7B this is indicated by reference 1162, where only one argument is required for the MCC in example.

In step 516, within each specific case block in which handling the MCCs for every existing/original constructor, the arguments, that were obtained from the subsequent invocations of the getArg method 1105, are now unpacked to the current stack, so that they match the formal parameter types of the constructor represented by the constructor entry 138 associated with the value of the current case block. In FIG. 7B, this is indicated by reference 1172.

In step 518, within those case blocks, insert bytecode that at runtime executes the mandatory constructor call represented by the value of the current case block passing the unpacked arguments from step 516 as arguments. In FIGS. 7A and 7B, this is indicated by references 127.

In step 520, the service module 110 inserts a default case that throws a NoSuchMethodError at runtime. In FIGS. 7A and 7B, this is indicated by reference 1130 in selector constructor 118-A and selector constructor 118-2.

In step 522, the service module 110 generates a closing brace to end bytecode generation of the switch/if-else code block. In FIGS. 7A and 7B, this is indicated by reference 1131 in selector constructor 118-A and selector constructor 118-2. The method of FIG. 3D completes, and control returns to FIG. 3C step 540.

Returning to FIG. 3C, in step 540, the service module 110 invokes the chosen selector constructor 118, passing the ‘originalArguments.’ In FIGS. 7A and 7B, this is indicated by reference 1132 in selector constructor 118-A and selector constructor 118-2.

In step 541, the method inserts bytecode to invoke the method invokeBody( ) as referenced by 1106 in FIG. 6B, passing the “this” object instance, the current constructor index and the “originalArguments” object array.

FIG. 6G provides further details of an example implementation of the method invokeBody( ) 1106.

In step 660, the invokeBody( ) method 1106 initiates execution by looking up the constructor entry 138, within the runtime constructor cache 132, for the input argument “callerlndex.” The constructor entry 138 object returned from the lookup is saved to local variable “callerEntry.”

Then in step 662, the method looks up the constructor signature 191 from the constructor data 202 in the “callerEntry” and saves the result in a local variable “signature.”

In step 664, the method looks up the original class name 190, from the constructor data 202, within the “callerEntry” and save the result in a local variable “originalClassName.”

In step 666, the method utilizes the class reload system 134 to lookup the most recent versioned helper class 124 for the “originalClassName” and store the result in a local variable “versionedHelperClass.”

In step 668, the method constructs the method name and signature of the specific “runConstructorBody” method, which is located in the versioned helper class 124, using the “originalClassName” and the “signature.”

Based on the constructed name and signature in the previous step, step 670 looks up the specific runConstructorBody( ) method within the versioned helper class 124 and saves the result in a local variable “runBodyMethod.” In one example, the lookup of the specific method is carried out by using the Reflection API of the Java platform.

In step 672, the method finally executes the “runBodyMethod” using the input “thisObject” and the “originalArguments” array. The “thisObject” and “originalArguments” array is indicated in FIG. 6B as reference 1290-2 and 1294-2 respectively.

Returning to FIG. 3C step 542, the method generates a closing brace for the selector constructor 118. In FIGS. 7A and 7B, this is indicated by reference 1133 in selector constructor 118-A and selector constructor 118-2. The bytecode generation of the selector constructor 118 for the classes is now complete. The method of FIG. 3C completes, and control returns to FIG. 3A, following completion of step 500.

In FIG. 3A, in step 550, the service module 110 includes a closing brace for the transformed class 184, which completes bytecode generation of the transformed class 184 for the current class being parsed. In FIGS. 7A and 7B, this is indicated by reference 1135. The bytecode generation of the transformed classes 184-A and 184-B are now complete. Upon completion of step 550, control passes to step 490.

In step 490, the service module 110 looks for more classes to process. If there are more classes, the method transitions to step 492 to go to the next class file, and then to step 404 to parse the current class for constructors. If there are no more classes to process in step 490, the method transitions to step 494 and ends processing.

Processing of Changed Classes: Applying the Method of FIG. 3A to Changed Class 104-A of FIG. 8A and Changed Class 104-B 8B

FIG. 8A and FIG. 8B include Java source code of changed classes 104-A and 104-B, respectively. Changed class 104-A has one original constructor 112-1 and one new constructor 114-1. Constructors are marked as original even if the body code of the constructor changes, as long as the MCC within a constructor does not change. Changed class 104-B has one changed constructor 113-2 and one new constructor 114-2.

In FIG. 8A, changed constructor 112-1 of class 104-A has mandatory constructor call 304, and new constructor 114-1 has mandatory constructor call 305. In FIG. 8B, changed constructor 113-2 of class 104-B has mandatory constructor call 306, and new constructor 114-2 has mandatory constructor call 307.

In FIG. 3A, in step 402, the class processing tool 120 of the service module 110 processes the changed classes 104-A and 104-B of FIG. 8A and FIG. 8B before they are passed to the user app 108. In step 404, the parser 106 parses the compiled bytecode of changed classes 104-A and 104-B. The parser 106 then identifies original constructor 112-1 and new constructor 114-1 of changed class 104-A. The parser 106 also identifies changed constructor 113-2 and new constructor 114-2 of changed class 104-B. In step 406, the service module 110 creates constructor entries 138-4 and 138-5 in FIG. 9B.

FIG. 9B shows example constructor entries 138 that the method of FIG. 3A creates in the constructor cache 130 in response to processing changed classes 104-A and 104-B. The constructor cache 130 already includes constructor entries 138-1 through 138-3 in FIG. 9A, which the service module 110 created when processing original classes 102-A and 102-B in FIGS. 4A and 4B.

In FIG. 9B, constructor entry 138-4 is created in response to the parser 106 identifying new constructor 114-1, “public A(int i, int j)” of changed class 104-A in FIG. 8A.

The parser 106 writes a value of “4” in constructor index 201-4 and value “A(int i, int j)” for constructor signature 191-4. The parser writes value “false” for the isOriginalConstructor( ) field 192-4 because the constructor was not present in original class 102-A, and writes value “1” for MCC index 203-4. Note that MCC index 203-4 references the java.lang. Object default constructor, given by constructor cache entry 138-1 with constructor index 201-1 value “1.” This is indicated by reference 139-1.

Constructor entry 138-5 is created in response to the parser 106 identifying new constructor 114-2, “public B(String message),” of changed class 104-B in FIG. 8B.

The parser 106 writes a value of “5” in constructor index 201-5 and value “B(String str)” for constructor signature 191-5. The parser writes value “false” for the isOriginalConstructor( ) field 192-5 because the constructor was not present in original class 102-B, and writes value “4” for MCC index 203-5. Note that MCC index 203-5 references the “A(int i, intj)” constructor, given by constructor cache entry 138-4 with constructor index 201-4 value “4.” This is indicated by reference 139-5.

For changed class 104-A, the parser 106 identifies one constructor within the call hierarchy of changed constructor 113-1, MCC 304 “super( ).” Because the value of MCC 304 of changed constructor 113-1 has not changed as compared to the value of MCC 301 of original constructor 112-1 (e.g. they both invoke “super( ),” the service module 110 does not create a new constructor entry 138 for MCC 304.

In a similar fashion, the parser 106 identifies one constructor within the call hierarchy of changed constructor 113-1, MCC 305 “super( ).” Because constructor entry 138-1 has already been created for “super( ),” the service module 110 does not create a new constructor entry 138 for MCC 305.

For changed class 104-B, the parser 106 identifies one constructor within the call hierarchy of changed constructor 113-2, MCC 306 “super(0, 200).” Changed class 104-B is a child class of changed class 104-A. Because constructor entry 138-4 has already been created for constructor 114-1 with signature “A(int i, int j),” the service module 110 does not create a new constructor entry 138 for MCC 306.

In a similar fashion, the parser 106 identifies one constructor within the call hierarchy of new constructor 114-2, MCC 307 “super(0, message.length).” Because constructor entry 138-4 has already been created for constructor 114-1 with signature “A(int i, intj),” the service module 110 does not create a new constructor entry 138 for MCC 307.

Returning to FIG. 3A, in step 408, because changed classes 104-A and 104-B are reloadable, the method transitions to step 410. According to step 410, the method parses the bytecode instructions within each constructor of the changed classes 104-A and 104-B to identify the bytecode of any mandatory constructor invocations.

In step 412, for each constructor 118, the method stores and/or updates unique identifiers for each mandatory constructor invocation MCC of any changed constructors 113.

In FIG. 9B, for changed class 104-A, MCC 304 of changed constructor 113-1 does not cause a change in the value of its associated MCC index 203-2. This is indicated by reference 139-2.

However, for changed class 104-B, MCC 306 of changed constructor 113-2 does cause a change in the value of its associated MCC index 203-3, and the parser 106 updates its value from “2” to “4” accordingly. This is indicated by reference 139-3. As a result, MCC index 203-3 “points” to constructor entry 138-4.

Returning to FIG. 3A, in step 414, the service module 110 determines that the classes 104-A and 104-B are changed classes 104. Because they are both changed classes, the method transitions to step 460.

In step 460, the service module 110 generates bytecode for versioned helper classes 124 for each changed class 104. Each versioned helper class 124 includes new method definitions for the methods of its associated changed class 104. The content of the new method definitions in each versioned helper class 124 are based on and include the bytecode instructions of each currently changed class 104.

FIG. 3B provides detail for FIG. 3A step 460.

The method of FIG. 3B generates bytecode of a versioned helper class 124 for each changed class 104. For each changed constructor 113 and for each new constructor 114 of each changed class 104, the method generates bytecode for a set of static methods getCurrentConstructorArgs( ) and runConstructorBody( ) that is the functional equivalent of their associated changed constructor 113/new constructor 114, in one implementation.

In step 462, the method begins creation of a versioned helper class 124 for the current changed class by generating bytecode of an opening brace of the versioned helper class 124.

FIG. 10A includes Java pseudocode that represents the bytecode of versioned helper class 124-A. FIG. 10B includes Java pseudocode that represents the bytecode of versioned helper class 124-B. The remaining references within FIGS. 10A and 10B are described in conjunction with the remaining steps of code path 111-2, included herein below.

Returning to FIG. 3B, in step 462, the service module 110 begins generating bytecode of versioned class 124-A for changed class 104-A and versioned helper class 124-B for changed class 104-B in FIGS. 10A and 10B.

In FIG. 10A, opening brace 1150 is generated for versioned helper class 124-A. In FIG. 10B, opening brace 1151 is generated for versioned helper class 124-B.

Returning to FIG. 3B, in step 464, the service module 110 identifies a first changed constructor 113 of the current changed class 104, referring to the identified constructor as the current constructor.

In step 466, the service module 110 parses the bytecode of the changed classes 104 to identify the mandatory constructor invocations of the current changed classes 104. Then, the service module 110 parses the current constructor collecting all bytecode instructions that are present in the changed class 104 before the currently identified mandatory constructor invocation, and places the instructions in a buffer.

In FIG. 8A, references 304 and 305 are associated with MCCs for changed class 104-A. In FIG. 8B, references 306 and 307 are associated with mandatory constructor invocations for changed class 104-B.

Returning to FIG. 3B, in step 468, the service module 110 generates bytecode for creating a first method “getCurrentConstructorArgs” for the current constructor, where the formal parameter types to the first method include an object instance of the current class, and a collected list of formal parameter types for the current constructor's MCC, and append the result to buffer.

In step 470, the service module 110 generates bytecode for storing the contents of the runtime stack into an array of objects that represent the arguments that will be passed to the current constructor's MCC, and append to buffer. The runtime stack refers to the actual values loaded onto the stack by method “getCurrentConstructorArgs” at runtime when executing the instructions that are present before the MCC, as collected in step 466.

In step 472, the service module 110 copies the buffer contents to the versioned helper class 124, generating a closing brace for the “getCurrentConstructorArgs” method and resets the buffer.

In FIGS. 10A and 10B, for versioned helper classes 124-A and 124-B, respectively, generated getCurrentConstructorArgs( ) methods are indicated by references 1156-1 through 1156-4.

Returning to FIG. 3B, in step 474, the service module 110 generates bytecode for function signature and opening brace of a second method “runConstructorBody” for the current constructor, where the formal parameters to the method are the same as the getCurrentConstructorArgs method, and append result to buffer.

In step 476, the service module 110 collects all bytecode instructions that are present after the MCC, and place the instructions in a buffer. In step 478, the service module 110 copies the contents of the buffer to versioned helper class 124, generating a closing brace for “runConstructorBody” and resets the buffer.

In FIG. 10A and FIG. 10B, for versioned helper classes 124-A and 124-B respectively, the produced runConstructorBody( ) methods are indicated by references 1157-1 through 1157-4.

Returning to FIG. 3B, in step 480, the service module 110 checks if there are any additional new or changed constructors in the current class. If this statement is true, the method transitions to step 483. In step 483, the service module 110 processes the next new or changed constructor and refers to it as the current constructor, and the method transitions back to the beginning of step 466 to process the current constructor.

Returning to step 480, when there are no more new or changed constructors in the current class, the method transitions to step 482. In step 482, the service module 110 generates bytecode for a closing brace of the versioned helper class 124 and resets the buffer, ending the flow.

As a result of processing changed class 104-A in FIG. 8A according to the method of FIG. 3B, versioned helper class 124-A of FIG. 10A is created. Versioned helper class 124-A includes a set of static methods 1156-1/1157-1 that is the functional equivalent of changed constructor 113-1 of changed class 104-A, and includes a set of static methods 1156-2/1157-2 that is the functional equivalent of new constructor 114-1 of changed class 104-A.

In a similar fashion, as a result of processing changed class 104-B in FIG. 8B also according to the method of FIG. 3B, versioned helper class 124-B of FIG. 10B is created. Versioned helper class 124-B includes a set of static methods 1156-3/1157-3 that is the functional equivalent of changed constructor 113-2 of changed class 104-B, and includes static method set 1156-4/1157-4 that is the functional equivalent of new constructor 114-2 of changed class 104-B.

Runtime Execution Flow of Example Client Class, Utilizing Selector Constructors to Correctly Invoke Changed and New Constructors in Reloaded Classes

FIG. 11 shows source code of a changed client class 104-C that creates instances of changed classes 104-A and 104-B. Specifically, the source code shows creation of an instance of changed class 104-A using its original constructor 112-1, and creation of an instance of changed class 104-A using its new constructor 114-1. Similarly, the source code shows creation of an instance of changed class 104-B using its changed constructor 113-2, and creation of an instance of changed class 104-A using its new constructor 114-2.

The service module 110 processes all of the changed classes before they are loaded by the user app 108. In example, the service module 110 will produce the changed classes referenced by FIGS. 8A and 8B for changed classes 104-A and 104-B respectively. The service module 110 also transforms the changed client class C 104-C. For the sake of a clear example produced selector constructor as well as the implicitly injected default constructor with additional “is-reloaded( )” checks as added by the invention are omitted here.

The service module 110 however, performs specific transformations to produce changed class 104-C′. In particular, the service module 110 performs bytecode modifications of constructor invocations in classes that attempt to invoke new constructors 114. Such invocations are converted into calls to the selector constructor 118-A and 118-B respectively.

When the selector constructors 118 are invoked at runtime, two arguments are passed to match the formal parameters of the selector constructor 118. The first argument is an object array that is packed from the original arguments. The second argument is the index value associated with the constructor cache entry 138. This index value is passed on by constructing a new ConstructorPlaceHolder object that internally stores the unique index value within the runtime constructor cache 132. This is indicated by references 1201 and 1202.

Reference 1201 points to an example where a client program (here, changed class 104-C′) invokes new constructor 114-1 of changed class 104-A. In a similar fashion, reference 1202 points to where the client program including changed class 104-C′ invokes new constructor 114-2 of changed class 104-B.

In response to a runtime execution path that leads to execution of the code statements indicated by reference 1201, the selector constructor 118-A in FIG. 7A, is invoked. As part of the invocation of the selector constructor 118-A the original (int, int) arguments “100, 300” are passed to the selector constructor 118-A. The passed arguments also include a new ConstructorPlaceHolder object with constructor cache index value “4” corresponding to constructor cache entry 138-4 in FIG. 9B. Execution flow now passes to the selector constructor 118-A in FIG. 7A.

Within selector constructor 118-A in FIG. 7A, the first code statement invokes the method getMCCIndex( ), as indicated by FIG. 6A reference 1102. In response to executing the detailed steps 602 through 610 of 1102 in FIG. 6C, the getMCCIndex( ) method returns the value “1,” which is the value of MCC Index 203-2 of constructor entry 138-4 in the constructor cache 130 of FIG. 9B.

Returning execution to the selector constructor 118-A within FIG. 7A, the switch block 1122-1 is entered, and case statement 125-2 is selected based on the returned MCCIndex. Within the block of code associated with the case statement 125-2, the getCurrentConstructorArgs method 1105 is invoked to obtain the runtime arguments to the MCC. Because the block of code associated with case statement 125-2 references an MCC for the java.lang. Object constructor with no parameters, method 1105 returns an empty object array which is ignored in the case block 125-2. Next, the MCC is made to the super constructor as indicated by reference 127, ending the switch block 1122-1.

Then, the execution continues outside the switch block 1122-1, with a call to the invokeBody method 1106. Execution then follows the detailed actions of method 1106 as indicated by steps 660-672 in FIG. 6G. In step 660, the method finds constructor cache entry 138-4 in FIG. 9B.

Returning to FIG. 6G step 662-664, the method looks up constructor data 202-4 and obtains the signature “A(int i, int j)” and the original class name “A.” In step 666, the class reload system 134 is utilized to locate the most recent versioned helper class 124-A, which is indicated in FIG. 8A.

Returning to FIG. 6G step 668, the method constructs the method name and signature “runConstructorBody(A original A, int i, int j)” based on the original class name found in step 664 and signature found in step 662. The constructed method is indicated by FIG. 10A reference 1157-2.

In step 670, the constructed method 1157-2 is looked up and invoked, passing as arguments the “this” object, which is the object currently under construction, and the original arguments “(100, 300).” Upon finishing the constructor body initialization of constructed method 1157-2, execution flow then returns to changed class 104-C′ of FIG. 11. As a result, the new changed class 104-A object is created and assigned to a local variable “a2,” which ends the example execution flow for invoking new constructor 114-1 of changed class 104-A.

In FIG. 11, in response to a runtime execution path that leads to execution of the code statements indicated by reference 1202, in, the selector constructor 118-B in FIG. 7B is invoked. As part of the invocation of the selector constructor 118-B, the original (String) argument “some message” are passed to the selector constructor 118-B. The passed arguments also include a new ConstructorPlaceHolder object with constructor cache index 201-5 value “5” corresponding to constructor cache entry 138-5 in FIG. 9B. Execution flow now passes to the selector constructor 118-B in FIG. 7B.

Within selector constructor 118-B in FIG. 7B, the first code statement invokes the method getMCCIndex( ), as indicated by FIG. 6A reference 1102. In response to executing the detailed steps 602 through 608, then step 612 and finally step 616 of 1102 in FIG. 6C, the getMCCIndex( ) returns the value “−2,” signaling that the MCC references a new constructor within the super class, in this example the new constructor 114-1 as indicated in FIG. 8A.

Returning execution to the selector constructor 118-B within FIG. 7B, the switch block 1122-2 is entered, and case statement 125-3 is selected based on the returned MCCIndex. Within the block of code associated with the case statement 125-3, the getCurrentConstructorArgs method 1105 is invoked to obtain the runtime arguments to the MCC.

FIG. 6E provides detailed steps for method 1105. Steps 630-640 utilizes constructor cache entry lookup to locate constructor cache entry 138-5, using the constructor date herein to lookup the specific getCurrentConstructorArgs( ) method as indicated by reference 1156-4 in FIG. 10B.

Returning to FIG. 10B, the located method 1156-4 is invoked and the produced object array which is returned has values “[0], [12],” where the value 12 for the second “int” parameter for the MCC is calculated as the length of the input String argument “some message”.

Then the execution flow returns to FIG. 7B, where the returned object array is saved in local variable named argsToSuper. Now, since the MCC index value currently known from the selector constructor is “−2,” a call to the external getTrueMCCIndex, as indicated in FIG. 6A by reference 1103 is made. Steps 620-624 of FIG. 6D provides details for method 1103, and for the example execution flow, the value 4 is returned, based on lookup of constructor entry 138-5, wherein the associated constructor data 202-5 has MCC index value 4.

Returning to FIG. 7B, the execution continues with a call to the selector constructor 118-A as indicated in FIG. 7A, which carries out steps for code statement 1201 in FIG. 11.

Then, the execution continues outside the switch block 1122-2, with a call to invokeBody method 1106. Execution then follows the detailed actions of method 1106 as indicated by steps 660-672 in FIG. 6G. In step 660, the method finds constructor cache entry 138-4 in FIG. 9B.

Returning to FIG. 6G step 662-664, the method looks up constructor data 202-5 and obtains the signature “B(String str)” and the original class name “B.” In step 666, the class reload system 134 is utilized to locate the most recent versioned helper class 124-B of FIG. 8A.

In step 668, the method constructs the method name and signature “runConstructorBody(B originalB, String str)” based on the found original class name and signature. The associated method that is generated is in FIG. 10B, indicated by reference 1157-4.

In step 670-672, the located method is looked up and invoked passing the “this” object, which is the object currently under construction, and the original argument “(some message).” Upon finishing the constructor body initialization of method 1157-4, the execution then returns back to changed class 104-C′, as indicated in FIG. 11, reference 1202. Upon resuming execution of changed class 104-C′, a new object for changed class 104-B is constructed and assigned to a local variable “b2”.

While this invention has been particularly shown and described with references to preferred embodiments thereof, it will be understood by those skilled in the art that various changes in form and details may be made therein without departing from the scope of the invention.

What is claimed is:

1. A method for updating a user app running within an Android virtual machine on a user device, comprising:
creating helper classes for changed classes of the user app, wherein the changed classes includes changed and/or new constructors; and
the user app reloading the helper classes on the user device.

2. The method of claim 1, further comprising creating the helper classes on a host system, and the host system sending the helper classes to the user device.

3. The method of claim 1, further comprising:
creating transformed classes for original classes of the user app, wherein the original classes include original constructors; and
the user app reloading the transformed classes on the user device along with the helper classes.

4. The method of claim 3, wherein creating the transformed classes comprises:
providing identifiers for the original constructors; and
transforming bytecode of the original classes into the transformed classes based on the identifiers.

5. The method of claim 3, wherein creating the transformed classes comprises:
transforming bytecode of the original constructors of the original classes into transformed constructors based on the identifiers; and
generating bytecode for a selector constructor within each of the transformed classes, wherein the selector constructor enables runtime selection of most recent versions of the transformed constructors for each of the transformed classes, and wherein the selector constructor enables runtime selection of most recent versions of the changed and/or new constructors for each of the changed classes.

6. The method of claim 5, wherein the selector constructor enables runtime invocation of most recent mandatory constructor calls and runtime invocation of most recent constructor bodies of the transformed classes based on the identifiers.

7. The method of claim 1, wherein creating the helper classes of the user app comprises:
providing identifiers for the changed and/or new constructors; and
transforming bytecode of the changed classes into the helper classes based on the identifiers.

8. The method of claim 7, wherein transforming bytecode of the changed classes into the helper classes comprises transforming bytecode of each changed and/or new constructor of the changed classes into a set of functionally equivalent static methods for each changed and/or new constructor based on the identifiers.

9. The method of claim 1, further comprising the user app running within a Dalvik Android virtual machine of the user device.

10. The method of claim 1, further comprising the user app running within an ART Android virtual machine of the user device.

11. A system for updating a user app, comprising:
a user device running the user app within an Android virtual machine of the user device; and
a host system creating helper classes for changed classes of the user app, the changed classes including changed and/or new constructors, and the host system sending the helper classes to the user app, which reloads the helper classes on the user device.

12. The system of claim 11, wherein the host system creates transformed classes for original classes of the user app, and wherein the original classes include original constructors, and wherein the user app reloads the transformed classes on the user device along with the helper classes.

13. The system of claim 12, wherein the host system creates the transformed classes by providing identifiers for the original constructors and transforming bytecode of the original classes into the transformed classes based on the identifiers.

14. The system of claim 12, wherein the host system creates the transformed classes by transforming bytecode of the original constructors of the original classes into transformed constructors based on the identifiers, and generates bytecode for a selector constructor within each of the transformed classes, wherein the selector constructor enables runtime selection of most recent versions of the transformed constructors for each of the transformed classes, and wherein the selector constructor enables runtime selection of most recent versions of the changed and/or new constructors for each of the changed classes.

15. The system of claim 14, wherein the selector constructor enables runtime invocation of most recent mandatory constructor calls and runtime invocation of most recent constructor bodies of the transformed classes based on the identifiers.

16. The system of claim 11, wherein the host system creates the helper classes of the user app by providing identifiers for the changed and/or new constructors, and transforming bytecode of the changed classes into the helper classes based on the identifiers.

17. The system of claim 16, wherein transforming bytecode of the changed classes into the helper classes comprises transforming bytecode of each changed and/or new constructor of the changed classes into a set of functionally equivalent static methods for each changed and/or new constructor based on the identifiers.

18. The system of claim 11, wherein the Android virtual machine is Dalvik.

19. The system of claim 11, wherein the Android virtual machine is ART.

20. The system of claim 11, wherein the user device includes a class reload system that enables the user app to reload the helper classes.

21. A method for updating a user app running within a virtual machine lacking runtime class redefinition support on a user device, comprising:
creating helper classes for changed classes of the user app, wherein the changed classes includes changed and/or new constructors; and
the user app reloading the helper classes on the user device.
